(19) United States
(12) Patent Application Publication
(10) Pub. No.: US 2010/0169937 A1
(43) Pub. Date: Jul. 1, 2010

(54) WIRELESS AD HOC NETWORKING FOR SET TOP BOXES

(76) Inventors: Peter Atwal, Longwood, FL (US); Ludger Schlicht, Boca Raton, FL (US)

Correspondence Address: STRATEGIC PATENTS P.C.., C/O PORTFOLIOIP, P.O. BOX 52050, MINNEAPOLIS, MN, 55402, US

(21) Appl. No.: 12/613,506

(22) Filed: Nov. 5, 2009

Related U.S. Application Data
(63) Continuation-in-part of application No. 12/418,363, filed on Apr. 3, 2009.
(60) Provisional application No. 61/111,384, filed on Nov. 5, 2008.
(60) Provisional application No. 61/112,131, filed on Nov. 6, 2008.
(60) Provisional application No. 61/118,232, filed on Nov. 26, 2008.
(60) Provisional application No. 61/121,169, filed on Dec. 9, 2008.
(60) Provisional application No. 61/042,431, filed on Apr. 4, 2008.
(60) Provisional application No. 61/042,442, filed on Apr. 4, 2008.
(60) Provisional application No. 61/074,930, filed on Jun. 23, 2008.
(60) Provisional application No. 61/082,618, filed on Jul. 22, 2008.
(60) Provisional application No. 61/082,642, filed on Jul. 22, 2008.
(60) Provisional application No. 61/084,738, filed on Jul. 30, 2008.
(60) Provisional application No. 61/084,773, filed on Jul. 30, 2008.
(60) Provisional application No. 61/086,242, filed on Aug. 5, 2008.
(60) Provisional application No. 61/094,394, filed on Sep. 4, 2008.
(60) Provisional application No. 61/094,546, filed on Sep. 5, 2008.
(60) Provisional application No. 61/094,584, filed on Sep. 5, 2008.
(60) Provisional application No. 61/094,591, filed on Sep. 5, 2008.
(60) Provisional application No. 61/094,594, filed on Sep. 5, 2008.
(60) Provisional application No. 61/094,611, filed on Sep. 5, 2008.
(60) Provisional application No. 61/095,298, filed on Sep. 8, 2008.
(60) Provisional application No. 61/095,310, filed on Sep. 9, 2008.
(60) Provisional application No. 61/103,106, filed on Oct. 6, 2008.

(30) Foreign Application Priority Data
Jul. 22, 2009 (US) PCT/US09/51467
Sep. 4, 2009 (US) PCT/US09/56130
Sep. 4, 2009 (US) PCT/US09/56134

(51) Int. Cl. H04N 7/20; H04N 7/173

(52) U.S. Cl. 725/68; 725/110; 725/119

(57) ABSTRACT

Enhancements are disclosed for wireless ad hoc networking tailored for set top box communications. Video selected with a set top box may be transmitted over a wireless network. Backchannel communication from a set top box may be communicated over a wireless network.

### RELATED APPLICATIONS

This application claims the benefit of the following U.S. Provisional patent applications: U.S. App. No. 61/111,384 filed on Nov. 5, 2008; U.S. App. No. 61/112,131 filed on Nov. 6, 2008; U.S. App. No. 61/118,232 filed on Nov. 26, 2008; and U.S. App. No. 61/121,169 filed on Dec. 9, 2008.

This application claims priority to the following PCT applications: PCT/U.S.09/56134 filed on Sep. 4, 2009; PCT/U.S.09/51467 filed on Jul. 22, 2009 and PCT/U.S.09/56130 filed on Sep. 4, 2009.

This application is a continuation-in-part of U.S. application Ser. No. 12/418,363 filed on Apr. 3, 2009 which claims the benefit of the following applications: U.S. App. No. 61/042,431 filed on Apr. 4, 2008; U.S. App. No. 61/042,442 filed on Apr. 4, 2008, U.S. App. No. 61/074,930 filed on Jun. 23, 2008; U.S. App. No. 61/082,618 filed on Jul. 22, 2008; U.S. App. No. 61/082,642 filed on Jul. 22, 2008; U.S. App. No. 61/084,738 filed on Jul. 30, 2008; U.S. App. No. 61/084,773 filed on Jul. 30, 2008 and U.S. App. No. 61/086,242 filed on Aug. 5, 2008; U.S. App. No. 61/094,394 filed Sep. 4, 2008; U.S. App. No. 61/094,546 filed on Sep. 5, 2008; U.S. App. No. 61/094,584 filed on Sep. 5, 2008; U.S. App. No. 61/094,591 filed on Sep. 5, 2008; U.S. App. No. 61/094,594 filed on Sep. 5, 2008; U.S. App. No. 61/094,611 filed on Sep. 5, 2008; U.S. App. No. 61/095,298 filed on Sep. 8, 2008; U.S. App. No. 61/095,310 filed on Sep. 9, 2008; U.S. App. No. 61/103,106 filed on Oct. 6, 2008.

Each of the foregoing applications is incorporated herein by reference in its entirety.

### FIELD OF INVENTION

This application relates generally to networking and more particularly to set top boxes that use wireless ad hoc networking.

### BACKGROUND

Television and other broadcast content is often enabled through the use of a set top box. A set top box operates as a tuner to decode individual channels from a broadcast signal that is received from a satellite or other broadcast infrastructure. The set top box may also obtain authorization to view various channels of broadcast content through a backchannel to the service provider. In a cable television environment, an upstream data channel for this authorization may conveniently be provided within the cable infrastructure; however, consumer satellite receivers do not typically provide a convenient backchannel, and satellite-based set top boxes typically required an additional, dedicated connection to handle data communications with a broadcaster such as a phone/modem interface or a network interface. This imposes additional infrastructure costs on consumers who must provide complementary connectivity, and may add phone usage charges or the like that must be borne by the consumer or the broadcast provider.

There remains a need for improved communications capabilities for set top boxes.

### SUMMARY

By adding wireless ad hoc networking capability to set top boxes, a data backchannel may be provided to support decoding and authorizing to view satellite broadcast content. Further, a deployment of multiple set top boxes with such capability permits shared use of a single Internet connection through a backhaul access point or the like. A method is disclosed herein for operating a backhaul access point comprising: observing one or more neighbor nodes in a wireless ad hoc network; identifying a set top box attached to one of the one or more neighbor nodes; receiving backchannel data from the set top box, the backchannel data including an Internet destination address; and forwarding the backchannel data to an internetwork for routing to the Internet destination address. The backchannel data may include a pay per view authorization. The backchannel data may include customer account information. The backchannel data may include information on customer viewing habits. The backchannel data may include information obtained from a keyboard connected to the set top box. The backchannel data may travel across one or more of a group comprising cable internet service, digital subscriber line (DSL) service, and dial up internet connection. The backchannel data may travel to the backhaul access point through a second set top box. The set top box may opportunistically use the wireless ad hoc network to communicate the backchannel data. The one or more neighbor nodes which are observed may be updated as new nodes enter the wireless ad hoc network. In embodiments, a node in a wireless network may comprise: a radio for operating within the wireless network; a backhaul access point connected to the radio; a processor programmed to: observe one or more neighbor nodes in the wireless network; identify a set top box attached to one of the one or more neighbor nodes; receive backchannel data from the set top box, the backchannel data including an Internet destination address; and forward the backchannel data to an internetwork for routing to the Internet destination address. In embodiments, a computer program product embodied in a computer readable medium that, when executed, may operate a backhaul access point by performing the steps of: observing one or more neighbor nodes in a wireless ad hoc network; identifying a set top box attached to one of the one or more neighbor nodes; receiving backchannel data from the set top box, the backchannel data including an Internet destination address; and forwarding the backchannel data to an internetwork for routing to the Internet destination address.

A method is disclosed for operating a backhaul access point comprising: observing one or more neighbor nodes in a wireless ad hoc network; identifying a set top box attached to one of the one or more neighbor nodes; receiving data from an internetwork addressed to the set top box; and delivering the data to the one of the one or more neighbor nodes attached to the set top box. The method may further comprise updating firmware on the set top box with the data which was delivered. The data may include promotional information. The data may include viewing recommendations. The data may travel to the set top box across one or more of a group comprising cable internet service, digital subscriber line (DSL) service, and dial up internet connection. The data may travel to the set top box through a second set top box. The set top box may opportunistically use the wireless ad hoc network to connect to the internetwork. The one or more neighbor nodes which are observed may be updated as new nodes enter the wireless ad hoc network. In embodiments, a node in a wireless network may comprise: a radio for operating within the wireless network; a backhaul access point connected to the radio; a processor programmed to: observe one or more neighbor nodes in the wireless network; identify a set top box attached to one of the one or more neighbor nodes; receive data from an internetwork addressed to the set top box; and deliver the data to the one of the one or more neighbor nodes attached to the set top box. In embodiments, a computer program product embodied in a computer readable medium that, when executed, may operate a backhaul access point by performing the steps of: observing one or more neighbor nodes in a wireless ad hoc network; identifying a set top box attached to one of the one or more neighbor nodes; receiving data from an internetwork addressed to the set top box; and delivering the data to the one of the one or more neighbor nodes attached to the set top box.

A method is disclosed for wireless communication of video with a fixture on a wireless ad hoc network comprising: receiving, at the fixture, a multi-channel broadcast from a signal source; selecting, with the fixture, a video signal from the multi-channel broadcast; and transmitting the video signal which was selected from the fixture to a node in the wireless ad hoc network. The fixture may be a set top box. The set top box may communicate over the wireless ad hoc network to a backhaul access point connected to an internetwork. The video signal may include obtaining authorization to view the video signal which was selected through a data network. The multi-channel broadcast may be communicated through the Internet. The multi-channel broadcast may be communicated by cable to the set top box. The multi-channel broadcast may be communicated by a satellite. The node may be a mobile device and further comprising handing off seamlessly the mobile device from the set top box to an ad hoc network access point, wherein the mobile device continues to receive video. The node may be a mobile device and further comprising handing off seamlessly the mobile device from the set top box to a second set top box, wherein the mobile device continues to receive video. The node may relay the video signal to a second node in the wireless ad hoc network. The method may further comprise transmitting the video signal which was selected by the set top box to a television attached to the wireless ad hoc network. The method may further comprise communicating data packets with the Internet by one or more mobile devices attached to the wireless ad hoc network through the set top box. The transmitting may include mobile broadband routable internet data. The multi-channel broadcast may include television signals. In embodiments, a system for video transmission may comprise: receiver circuitry configured to receive multi-channel broadcast from a signal source; tuner circuitry configured to select a video signal from the multi-channel broadcast thereby providing a selected signal; and transmitter circuitry configured to transmit the video signal which was selected over a wireless ad hoc network. In embodiments, a node in a wireless network may comprise: a radio for operating within the wireless network; a processor programmed to: receive, at the node, a multi-channel broadcast from a signal source; select a video signal from the multi-channel broadcast; and transmit the video signal which was selected from the node to a second node in the wireless network. In embodiments, a computer program product embodied in a computer readable medium that, when executed, communicates video with a fixture on a wireless ad hoc network by performing the steps of: receiving, at the fixture, a multi-channel broadcast from a signal source; selecting, with the fixture, a video signal from the multi-channel broadcast; and transmitting the video signal which was selected from the fixture to a node in the wireless ad hoc network.

In embodiments, a device may comprise: a satellite receiver configured to receive a unidirectional broadcast satellite signal from a satellite antenna and to decode at least one channel of video broadcast content from the unidirectional broadcast satellite signal based upon an authorization obtained over an Internet backchannel; a wireless radio; and signal processing circuitry configured to operate the wireless radio to: discover an ad hoc network; join the ad hoc network as a node; and provide the Internet backchannel through the ad hoc network, whereby the authorization can be obtained. The signal processing circuitry may be further configured to operate the node as one or more of a source and a destination of peer-to-peer traffic within the ad hoc network. The signal processing circuitry may be configured to communicate over the ad hoc network to authorize the satellite receiver to decode the at least one channel of video broadcast content. The signal processing circuitry may be further configured to deliver broadband Internet connectivity to a user from the ad hoc network. One or more of the satellite receiver, the wireless radio, and the signal processing circuitry may be integrated into a set top box with a connector for delivering the at least one channel of video broadcast content to a television. A remote control may be included for remote access of the set top box. The connector includes one or more of an RF connector, a composite video connector, an S-video connector, a component video connector, a D-Sub connector, a Digital Visual Interface connector, a High Definition Multimedia Interface connector, and an IEEE 1394 connector. A backhaul connection may be included and the signal processing circuitry may be further configured to operate as a backhaul access point in the ad hoc network. In embodiments, a method for operating a set top box with a wireless radio is disclosed comprising: receiving a unidirectional broadcast satellite signal from a satellite receiver; decoding at least one channel of video broadcast content from the unidirectional broadcast satellite signal based upon an authorization obtained over an Internet backchannel; discovering an ad hoc network with the wireless radio; joining the ad hoc network as a node; and providing the Internet backchannel to the ad hoc network, whereby the authorization can be obtained. In embodiments, a computer program product embodied in a computer readable medium that, when executed, may operate a set top box with a wireless radio by performing the steps of: receiving a unidirectional broadcast satellite signal from a satellite receiver; decoding at least one channel of video broadcast content from the unidirectional broadcast satellite signal based upon an authorization obtained over an Internet backchannel; discovering an ad hoc network with the wireless radio; joining the ad hoc network as a node; and providing the Internet backchannel to the ad hoc network, whereby the authorization can be obtained.

Various features, aspects, and advantages of various embodiments will become more apparent from the following further description.

### BRIEF DESCRIPTION OF THE DRAWINGS

The following detailed description of certain embodiments thereof may be understood by reference to the following figures wherein:

FIG. 1 is a block diagram of a Mobile Ad Hoc Network (MANET).

FIG. 2 shows a MANET Wireless Protocol that may be used by devices within a MANET.

FIG. 3 is a block diagram of a node in a wireless ad hoc network.

FIG. 4 shows a set top box using a wireless network for a backchannel.

FIG. 5 shows a system where video is communicated from a set top box to mobile devices.

FIG. 6 shows a system where cable service is the provider of the video source.

FIG. 7 shows a satellite broadcast system using a wireless ad hoc network for backchannel communications.

FIG. 8 shows a set top box that sends video over a wireless network to a neighboring television.

FIG. 9 shows a system for set top box backchannel communication.

FIG. 10 is a block diagram of a set top box.

FIG. 11 is a block diagram of a set top box with a phone connection.

FIG. 12 is a block diagram of a roof mount fixture for wireless ad hoc networking.

FIG. 13 is a flowchart for set top box transmission of video.

FIG. 14 is a flowchart for wireless backchannel communication with a set top box.

### DETAILED DESCRIPTION

The present disclosure provides a description of various apparatus and techniques that facilitate wireless ad hoc network communications.

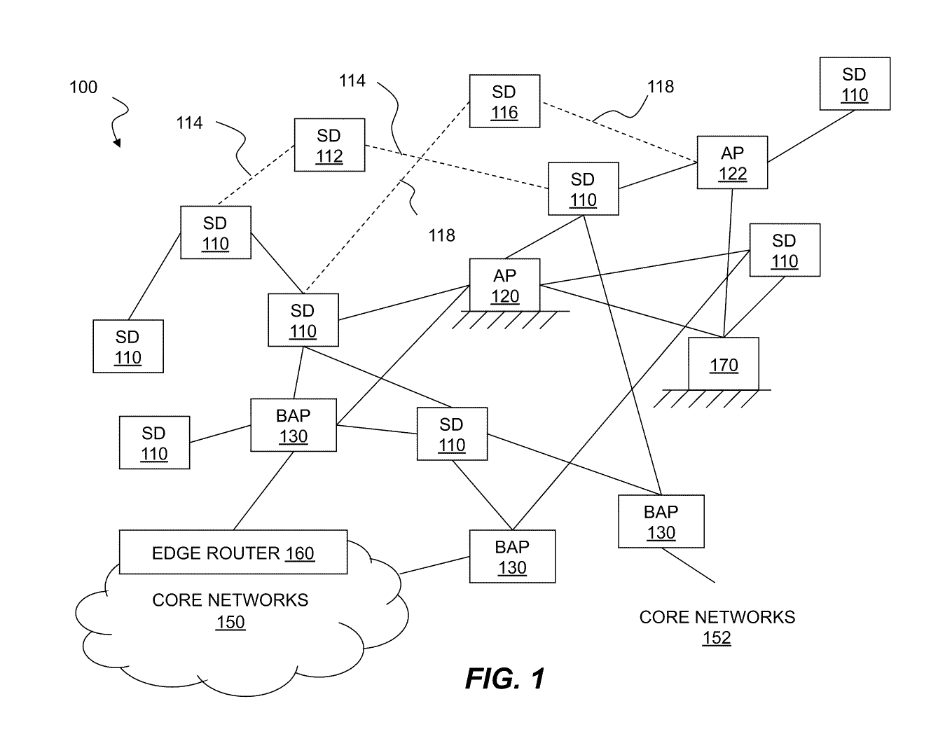

FIG. 1 shows a Mobile Ad Hoc Network (MANET) that may be used with the systems and methods described herein. In general, a MANET 100 (also referred to generally herein as a network 100) may include subscriber devices 110, access points 120, and backhaul access points 130 (for coupling to a core network 150 such as the Internet), all generally interconnected to one another as shown for example in FIG. 1. Without limiting the generality of the foregoing, one or more of the subscriber devices 110 may be a stationary device 170 that does not geographically move within the MANET 100. It will be understood that the device-to-device links illustrated in FIG. 1 are for purposes of illustration only, and in no way are intended to limit the nature or number of links between devices in the MANET 100, which may be created, removed, and/or modified over time according to any corresponding protocols followed by the devices within the MANET 100. In general, the links among devices or components within the MANET 100 are wireless links, although wired links may optionally be employed in various locations such as between the backhaul access point 130 and the core networks 150. In order to maintain the MANET 100, typically one or more protocols are shared among the participating devices to control creation, removal, and modification of individual data links between devices, and to route traffic and control information among the devices. The term protocol as used herein generally refers to any and all such rules, procedures, and/or algorithms used in maintaining the MANET 100, unless a specific protocol is explicitly stated or otherwise clear from the context.

Subscriber devices 110 may include any general purpose nodes participating in the MANET 100 according to suitable protocols. Subscriber devices 110 may, for example, include terminal nodes that send or receive data. Subscriber devices 110 may also or instead suitably be employed as intermediate nodes to route traffic to and from other subscriber devices 110. Thus an ad hoc network as described herein is generally extensible, and as new subscriber devices 110 appear within the MANET 100, they may form a part of the MANET 100 fabric that routes traffic among other nodes. A new subscriber device 112 may be introduced to the MANET 100 with new links 114 being added as the new subscriber device 112 is detected. Devices may also periodically leave the MANET 100 such as a departing subscriber device 116. As the departing subscriber device 116 leaves the network, links 118 between the departing subscriber device 116 and other subscriber devices 110, access points 122, stationary devices 170, backhaul access points 130, and/or other devices may be severed. This may occur, for example when a device moves beyond geographical boundaries of the MANET 100, when devices in the MANET are turned off (or their wireless or networking capabilities are suspended), or when a hardware or software malfunction occurs. The MANET 100 may, in a centralized or distributed manner, detect new and/or departing devices and/or links in order to maintain substantially continuous connectivity for devices in the MANET 100.

In general, a subscriber device 110 may include any network or computing device that includes a wireless interface, one or more network protocol stacks, and the like adapted to participate in the MANET 100. The Internet Protocol may usefully be employed in subscriber devices 110 within the MANET 100 in order to use well-established addressing schemes and the like. A subscriber device 110 may include without limitation a cellular phone, personal digital assistant, wireless electronic mail client, laptop computer, palmtop computer, desktop computer, video device, digital camera, electrical instrument, sensor, detector, display, media player, navigation device, smart phone, wireless networking card, wireless router (e.g., for a local WiFi network), storage device, printer, or any other device that might usefully participate in a network. In some embodiments subscriber devices may include a GPS receiver providing a position and timing reference. In embodiments, each subscriber device 110 may be authenticated and/or authorized before being granted access to the MANET 100.

Access points 120 may be provided to establish a permanent or otherwise generally stable infrastructure to the MANET 100. An access point 120 may be fixed in location or may be limited in the amount that it can move or may be a mobile access point 122 that can freely move within the MANET 100. The access points 120 may employ identical network functionality and protocol stacks as the subscriber devices 110 described above. The access points 120 may also or instead encapsulate different functionality consistent with a more specialized role in the MANET 100. In one aspect, the access points 120 may have no associated computing device that originates or consumes network traffic. That is, the access points 120 may simply form a mesh of participants in the MANET 100 and relay traffic among other network participants. An access point 120 may also include a physical connection to a power infrastructure so that it may be physically installed at a location and operate autonomously without requiring regular maintenance for battery changes and the like. In another aspect, access points 120 may include some minimal supplemental circuitry related to, e.g., status and diagnostics, or for receiving software updates and the like. By arranging a spanning network of access points 120 network continuity may be improved in areas where subscriber devices 110 are not present or are not expected to be present with any regularity. In embodiments an access point 120 may be of a size and weight making it suitable for mounting and/or concealment in a variety of locations including indoor and outdoor locations, and including mounting on walls, floors, ground, ceilings, roofs, utility poles, and so forth.

Each access point 120 may include or utilize a timing reference such as any of the Network Timing Protocols described in the Internet Engineering Task Force's Request for Comments (RFC) 778, RFC 891, RFC 956, RFC 958, RFC 1305, RFC 1361, RFC 1769, RFC 2030, and RFC 4330, all published by The Internet Engineering Task Force. Each access point may also, or instead, include a GPS receiver providing a position and timing reference, or any other open or proprietary timing system may be employed.

In embodiments the access points 120 may have a greater transmit power and/or a greater antenna gain than mobile subscriber devices 110, thus providing greater physical coverage than some other devices within the MANET 100.

The MANET 100 may include one or more backhaul access points 130 that generally operate to connect nodes within the MANET 100 to a core network 150 such as the Internet. A core network 150 may be a fixed network or may be an infrastructure network. On one interface, a backhaul access point 130 may have a wireless radio interface, one or more protocol stacks and other components of other nodes within the MANET 100. On another interface, the backhaul access point 130 may provide any suitable interface to the core network 150. The backhaul access point 130 may, for example, be deployed at a fiber access point or the like that provides high-speed data capacity for Internet traffic or the like. For example and without limitation, the fiber access point may include a Gig-E router site or an OC-3/12 add-drop multiplexer site. In an embodiment the backhaul access point 130 may include two Gig-E interfaces for backhaul connections. It will be understood that any number and variety of suitable interfaces for backhaul connections may be usefully employed with a backhaul access point 130 as described herein.

A backhaul access point 130 may serve multiple access points 120 within the MANET 100, and may distribute network load across those access points. Alternatively, a single backhaul access point 130 may serve a single access point 120. The number of access points 120 served by a backhaul access point 130 may depend on various factors such as the amount of intra-MANET traffic and extra-MANET traffic, the nature and direction of multicast versus unicast data, and so forth. This association between backhaul access points 130 and access points 120 may change from time to time depending on the presence of other subscriber devices 110 within the area, network conditions, network traffic demands, and so forth. In some cases or under some operating conditions, an access point 120 may be associated with more than one backhaul access point 130.

An edge router 160 may be included between the core network 150 and one or more backhaul access points 130. The edge router 160 may facilitate routing between the MANET 100 and the core networks 150. The core networks 150 may be connected through an edge router 160 to a backhaul access point 130 or may be directly connected to a backhaul access point 130 without going through the edge router 160. More than one edge router 160 may be used to contact multiple backhaul access points 130. In embodiments one edge router may contact multiple backhaul access points 130. The edge router 160 may include any devices or systems for maintaining connectivity between the MANET 100 and the core networks 150, and may further support or enhance network activity within the MANET 100. For example, the edge router 160 may include an industry standard and/or proprietary Address Resolution Protocol server, an application server, a Virtual Private Network server, a Network Address Translation server, a firewall, a Domain Name System server, a Dynamic Host Configuration Protocol server, and/or an Operations, Administration, Maintenance and Provisioning server, and the like, as well as any combination of the foregoing. These various components may be integrated into the edge router 160 or may be provided as separate (physical and/or logical) systems that support operation of the edge router 160. These supporting systems may in general support operations such as broadband Internet connectivity within the MANET 100, broadcast communications crossing between the MANET 100 and the core networks 150, and so forth, as well as the use of multiple backhaul access points 130 to efficiently route inter-MANET (and/or intra-MANET) traffic among subscriber devices 110.

The core networks 150 may include any network resources outside the MANET 100. As shown in FIG. 1, there may be any number of different core networks, which may for example include a second core network 152 connected to the MANET 100 through a backhaul access point 130. The second core network 152 may be wholly independent from the core network 150, or may connect to the core network 150 through a fixed or other type of network. The core networks 150 may connect disparate, geographically remote and/or local instances of the MANET 100 to form a single network. The core networks 150 may include any and all forms of IP networks, including LANs, MANs, WANs, and so on. The core networks 150 may also or instead include the public Internet, the Public Switched Telephone Network, a cellular communications network, or any other network or combination of networks for data traffic, voice traffic, media broadcasting, and so forth. In other embodiments the core networks 150 may consist exclusively of a single zone of administrative control, or a number of zones of administrative control, or some combination of an administrative zone and any of the foregoing.

The stationary device 170 may include any subscriber device 110 that, for whatever reason, does not physically move within the MANET 100. In general, such fixed physical points within the MANET 100 may provide useful routing alternatives for traffic that can be exploited for load balancing, redundancy, and so forth. This may include, for example, a fixed desktop computer within the MANET 100.

Communication within the MANET 100 may be accomplished via protocols, referred to collectively herein as the MANET Wireless Protocol (MWP). In general, any of the nodes above that participate in the MANET 100 according to the MWP may include a hardware platform enabling radio software and firmware upgrades, which may include for example a dedicated or general purpose computing device, memory, digital signal processors, radio-frequency components, an antenna, and any other suitable hardware and/or software suitable for implementing the MWP in participating nodes.

In embodiments, any of the foregoing devices such as one of the access points 120 may also include an adapter for other networks such as an Ethernet network adapter or equivalent IP network adapter, router, and the like, so that non-MANET equipment can participate in the MANET 100 through the device. It will also be appreciated that, while connections to core networks 150, 152 are shown, these connections are optional. A MANET 100 (with or without access points 120) may be maintained independently without connections to any other networks, and may be usefully employed for the sole purpose of trafficking data among subscriber devices 110.

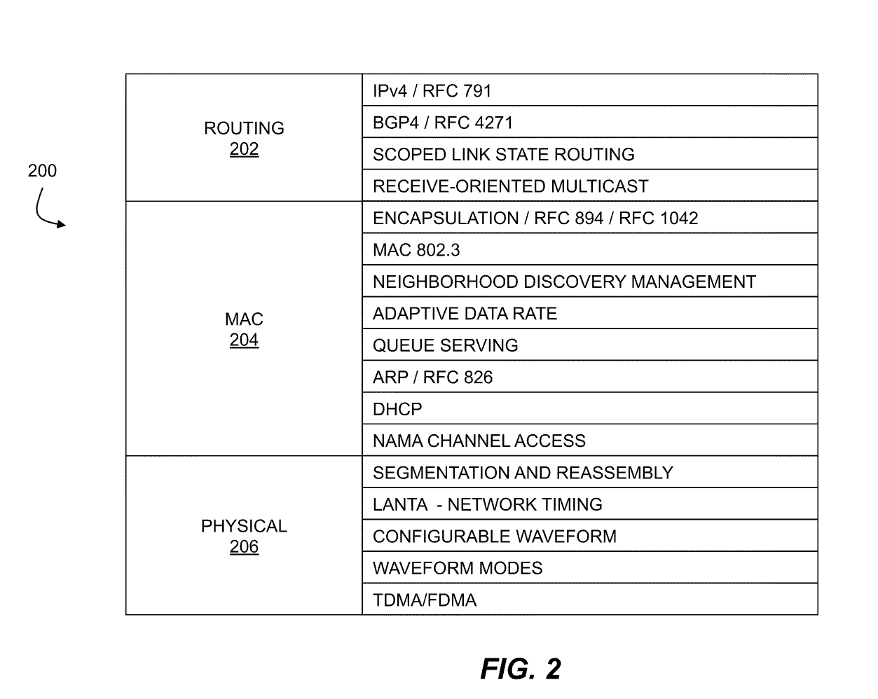

FIG. 2 shows a MANET Wireless Protocol (MWP) stack that may be used by devices within the MANET 100 of FIG. 1.

In general, a protocol stack provides a reference model for communications among network devices so that functions necessary or useful for network communications are available while each functional layer can be designed, modified, and/or deployed free from the implementation details of neighboring layers. Methods and systems disclosed herein may employ any suitable protocol stack to support wireless communications among devices. This may include, for example the Open Systems Interconnection (OSI) Reference Model (with seven layers labeled Application, Presentation, Session, Transport, Network, Data Link (LLC & MAC), and Physical) or the TCP/IP model (with four layers labeled Application, Transport, Internet, Link) along with any adaptations or variations thereof suitable for use in a MANET, or any entirely different computer network protocol design. The lower layer(s) of a protocol stack that support physical interfaces, medium access control, routing and the like may be modified to accommodate mobile wireless ad hoc networking while industry-standard protocols are supported at the routing layer (e.g., for routing at a MANET boundary and/or beyond) and above. In this manner, industry standard applications and devices may be employed within the MANET while using the MANET infrastructure to manage communication. Thus, applications designed for the fixed Internet may be deployed in the MANET, and vice versa, without requiring intervention, such as of a carrier or service provider.

In various embodiments, functions within each layer may be augmented, reduced, or modified on a device-by-device basis. For example, the functionality of each of the layers may be pruned to meet specific requirements without deviating from the scope of the invention. The function(s) of a particular layer may be implemented in software and/or hardware without deviating from the scope of the invention.

As shown in FIG. 2, the layers of a MANET Wireless Protocol (MWP) stack may include a routing layer 202, a medium access control (“MAC”) layer 204, and a physical layer 206. By way of example and not of limitation, each of these layers and the associated functions are now discussed in greater detail.

The routing layer 202 may implement industry standards for routing such as Internet Protocol version 4 (IPv4) as described in RFC 791 and Border Gateway Protocol 4 (BGP4) as described in RFC 4271. The routing layer 202 may also implement wireless ad hoc networking technologies to replace, e.g., Open Shortest Path First (OSPF) as described in RFC 2740 such as scoped link state routing and/or receiver-oriented multicast. This layer may for example support industry-standard unicast and multicast routing protocols at a boundary between a MANET and a fixed network while providing propriety unicast and multicast routing within the MANET.

The Medium Access Control (MAC) layer 204 may implement industry standards for medium access control and related functions, such as RFC 894 and RFC 1042 for encapsulation, Institute of Electrical and Electronic Engineers (IEEE) 802.3 for Media Access Control (MAC), RFC 826 for Address Resolution Protocol (ARP), and RFC 2131 for Dynamic Host Configuration Protocol (DHCP). The MAC layer 204 may also implement wireless ad hoc networking technologies to replace, e.g., IEEE 802.2 LLC and IEEE 802.1q such as neighbor discovery management, adaptive data rates, and proprietary queue serving. Similarly, RFC 1661 and 2516 for Point-to-Point Protocol (PPP) may be substituted with proprietary link scheduling and/or node activated multiple access (NAMA) channel access. The MAC layer 204 may, for example, support quality of service differentiation using channel access and/or queue servicing to prioritize delay-sensitive traffic. In this layer, neighbor management may establish network entry for devices and track changes in each node's local one-hop and two-hop neighborhoods, such as through a message exchange with one-hop neighbors. The MAC layer 204 may support adaptive power control by adjusting transmit power on a link-by-link basis in a MANET in a manner that, e.g., maximizes transmission capacity while minimizing interference according to link conditions and topology. Adaptive data rates may be employed on a link-by-link basis to maximize transmission capacity according to individual link conditions. Queue servicing may provide buffers for data awaiting transmission through a physical layer 206 interface, and may incorporate differentiated quality of service. At the same time, channel access may be used to determine which node transmits in each Time Division Multiple Access (TDMA) time slot, with a schedule influenced by quality-of-service parameters.

The physical layer 206 may implement wireless technologies such as segmentation and reassembly of physical layer transmissions, local area node tracking algorithm (LANTA) network timing, and slot-by-slot configurable waveforms, as well as multiple waveform modes including time domain multiple access and frequency domain multiple access waveforms, or more generally any waveforms that support multiplexing or multiple access based on time, frequency, coding, or the like. In general network timing is also provided within the physical layer 206, and may correct time and frequency errors to ensure that all nodes are operating with a common time base. At the same time, waveform mode self-discovery may be employed so that each receiver can autonomously discover which waveform mode was sent from a transmitter.

These and other functions and details of operation of a MANET Wireless Protocol stack are described in greater detail for example in U.S. application Ser. No. 12/418,363 filed on Apr. 3, 2009, the entire contents of which are incorporated herein by reference.

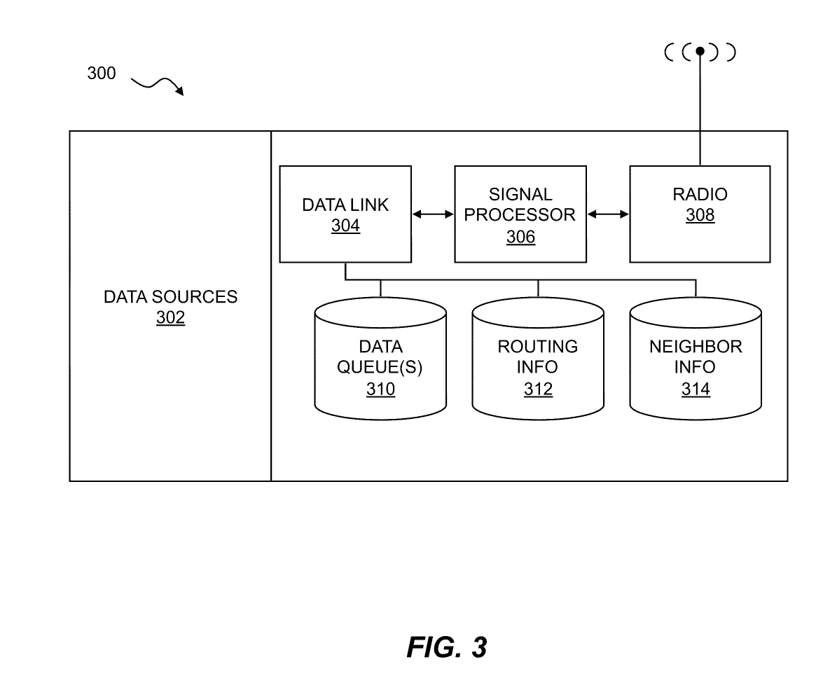

FIG. 3 is a block diagram of a node in a wireless ad hoc network such as the MANET described above. The node may be any of the devices described above, such as a subscriber device, access point, or backhaul access point. In general the node 300 may include data sources 302, a data link 304, a signal processor 306, a radio 308, data queues 310, routing information 312, and neighborhood information 314. It will be understood that the following description is general in nature, and that numerous arrangements of processing, storage, and radio frequency hardware may be suitably employed to similar affect. This description is intended to outline certain operations of a MANET node relevant to the systems and methods described herein, and in no way limits the invention to the specific architecture shown in FIG. 3.

The data sources 302 may include any applications or other hardware and/or software associated with the node 300. This may include, for example, programs running on a laptop or other portable computing device, a web server or client, a multimedia input and/or output sources such as a digital camera or video, and so forth. More generally any device, sensor, detector, or the like that might send or receive data may operate as a data source 302 in the node 300. It will be further understood that some nodes such as access points 104 may not have independent data sources 302, and may function exclusively as MANET 100 network elements that relay data among other nodes and/or provide network stability as generally described above.

The data link 304 may include hardware and/or software implementing data link layer functionality such as neighbor management, segmentation and reassembly of data packets, Quality of Service (QoS) management, data queue servicing, channel access, adaptive data rates, and any other suitable data link functions. In general, the data link 304 controls participation of the data sources 302, and more generally the node 300, in a MANET. It will be understood that the data link 304 in FIG. 3 may implement any number of lower layer (e.g., physical layer) or higher layer (e.g., routing, transport, session, presentation, application) protocols from a conventional Open Systems Interconnection (OSI) Model, or any such protocols and related functions may be implemented elsewhere within the node 300, such as in an IP stack executing on the data source 302, or in firmware within the signal processor 306 or radio 308, or in additional functional blocks not depicted in FIG. 3. For example, routing protocols may be implemented within hardware/software of the data link 304 in order to ensure that nodes in the MANET 100 share appropriate routing functions. Thus it will be appreciated that while the certain elements discussed herein might suitably be placed within the data link layer of a formal protocol stack, the systems and methods of this disclosure might also or instead be implemented with variations to a conventional protocol stack, or without any formal protocol stack whatsoever.

The data link 304 may include a link manager that collects neighbor information from the data link layer, and may form and maintain the neighborhood information 314 for the node 300. This table may be used to establish routes to neighbors, and may be updated periodically with information from one and two hop neighbors as described further below. The link manager may monitor statistics on all active links for a node on a link-by-link basis in order to support link quality calculations and other functions described herein. The term metadata is used herein to generally refer to the neighborhood information 314 for the node 300 or any other information characterized one or more nodes, data links, or other network characteristics that might be shared among nodes to describe the network in which nodes are participating and communicating. In general, the metadata includes at least one item of metadata, although any number of metadata items might be usefully employed according to the number of nodes in a neighborhood and the amount of information to be exchanged among nodes.

The signal processor 306 may include any signal processing circuitry for waveform processing and timing functions associated with transceiving data at the node 300. This may include, for example, network timing, time-slot and/or frame-based waveform configuration, maintenance of one or more families of Orthogonal Frequency Division Multiplexing waveform modes (or other transmit mode waveforms), receiver detection of waveform modes, error correction coding, and so forth. In general, the signal processor 306 may be implemented in any suitable combination of digital signal processors, field programmable gate arrays, application-specific integrated circuits, microprocessors, or other general or special-purpose computing devices, as well as any other combination of digital and/or analog electronics useful for the various signal processing functions described herein.

In one embodiment, a family of Orthogonal Frequency Division Multiplexing (OFDM) waveforms may be employed for adaptive data rate communications. The modes of the OFDM waveforms may, for example, include 7.2 MHz Quadrature Phase-Shift Keying (QPSK), 4.8 MHz QPSK, 2.4 MHz QPSK, 1.2 MHz QPSK, 1.2 MHz Binary Phase-Shift Keying (BPSK), or the like. The effective data rate for transmit waveforms may be affected by other parameters such as error correction. In order to facilitate implementation of an adaptive rate system, the transmit modes may be organized into an ordered list of monotonically increasing data rates matched to correspondingly decreasing signal robustness, thus permitting unique mapping of link quality to transmit mode. In one aspect, the actual waveform mode selected to transmit data on a link may be adaptively selected according to any suitable evaluation of link quality for links to neighboring nodes.

The radio 308 in general operates to transmit data from the data queue(s) 310, as organized and encoded by the data link 304 and the signal processor 306 (along with any control information, packet header information, and so forth), over a wireless air interface to other nodes in a MANET, and to perform complementary data reception. The radio 308 may include any radio frequency analog circuitry and the like, and may be coupled to the signal processor 306 which converts data and control information between a digital representation used within the node 300, and an analog representation used in radio frequency communications with other nodes. In embodiments, a low power radio 308 may be employed, such as where the node 300 is a battery-powered mobile device. In other embodiments, a high-power radio 308 may be employed, such as where the node 300 is an access point or backhaul access point connected to a fixed power infrastructure. In an embodiment, the radio 308 and signal processor 306 provide adaptive data rate coding capable of changing transmit modes, error correction, and the like according to measured link quality.

The data queue(s) 310 may include any data for transmission from the node 300. This may include, for example, data from the data sources 302, data that is relayed by the node 300 from other nodes in the MANET, and/or control information scheduled for transmission within data packets from the node 300. The data queue(s) 310 may be organized in any suitable fashion, and may include a single first-in-first-out queue, multiple queues, prioritized queues, and the like. In one embodiment, the node 300 may include multiple prioritized queues to assist in providing various service levels, such as for QoS traffic. In general, data in the data queue(s) 310 is delivered according to any suitable queuing mechanism to the data link 304, signal processor 306, and radio 308 for transmission within the MANET.

Routing information 312 such as a routing or forwarding table may be provided to support routing functions by the node 300. In general, this may include, for example, a destination address or identifier, a cost of a path to the destination (using any suitably cost calculation), and a next hop on that path. Other information such as quality of service and other metrics for various routes and links may also be provided for more refined routing decisions.

Neighborhood information 314 may be maintained in a database, flat file, routing table, or other suitably organized volatile or non-volatile storage within the node 300. The neighborhood information 314 generally supports the creation and maintenance of the MANET as well as routing functions of each MANET node. Within the MANET, each node may interact with other nodes to autonomously identify and maintain local network connections, shift capacity, dynamically form routes throughout the network, and so on. The routing functions of the node (as supported by the neighborhood information 314) may accommodate delay-sensitive (e.g. voice) traffic, delay-tolerant traffic with quality of service (QoS) prioritization, and so on.

The neighborhood information 314 may include an identification of neighboring nodes along with information relating to those nodes. This may include one-hop neighbors (i.e., neighboring nodes in direct wireless communication with the node 300), two-hop neighbors (i.e., neighboring nodes that communicate with the node 300 through only one other node), or any other nodes or participants within the MANET. In one aspect, neighborhood information 314 includes link quality information for the radio 308, which may be obtained from any combination of physical layer and data link data, and may be employed to adapt the data rate of communications according to currently present channel conditions. The neighborhood information may also include QoS data used to select next hops for QoS data. Other useful information may include bandwidth utilization, node weights, node position (either logical or physical), and queue latency for each QoS type and/or other priority type.

In one aspect, the neighborhood information 314 may be gathered during periodic exchanges (such as during control transmissions) with neighboring nodes, which may occur under control of the link manager of the data link 304. For example, the node 300 may determine output bandwidth (i.e., data transmit requirements) for each link that the node 300 has with a neighbor, and may transmit this to one-hop neighbors. Similarly, the node 300 may receive output bandwidth from each one-hop neighbor. Using this data, each node 300 may further calculate its own input bandwidth (i.e., data receive requirements) from each link to a neighboring node, and this information may in turn be exchanged with one-hop neighbors. Following a system-wide exchange with one-hop neighbors, the node 300 (and every other node in the MANET) may calculate a node weight that represents relative output requirements for the node 300. For example, the node weight, W, may be calculated as:

$$W = \frac{{BW}_{out}}{{BW}_{out} + {BW}_{i n}} \qquad [ Eq . 1 ]$$

where BWₒᵤₜ is the total output or transmit requirements for each link of the node 300, and BWᵢₙ is the total input or receive requirements for each link of the node 300. Finally, the node 300 may transmit the node weight to each neighboring node, and may in turn receive a node weight from each neighboring node. It will be appreciated that the node weight, W, may be further processed for use with other neighborhood information 314, such as by limiting the value according to the number of bits used for control information, or by providing a supplemental adjustment to the node weight to further refine control of routing or other MANET functions. Sharing of information for maintenance of the neighborhood information 314 may be controlled, for example, by the data link 304, which may apply any suitable technique to determine when to share information with one hop neighbors. In one aspect, the data link 304 may transmit data whenever a change is detected in the MANET such as an addition or deletion of a node.

As noted above, any of the neighborhood information 314, routing information 312, and/or data queue(s) 310, as well as status or other information concerning any of the foregoing, may usefully be shared among the nodes participating in a network, and all such information is intended to fall within the meaning of metadata as that term is used herein.

In another aspect, for a MANET that has location-aware nodes 300 (e.g., using Global Positioning System (GPS) data, signal strength data, and so forth), the neighborhood information 314 may include position data in order to support location-based routing and the like.

It will be understood that while a MANET is described as one useful platform for wireless ad hoc networking, any system with capabilities to support the systems and methods described below may also or instead be employed, including without limitation Mobile Broadband Routable Internet systems as described in U.S. application Ser. No. 12/418,363 filed Apr. 3, 2009. Having described a suitable type of wireless ad hoc networking in general terms, the description now turns to a more detailed treatment of set top boxes with wireless ad hoc networking capability.

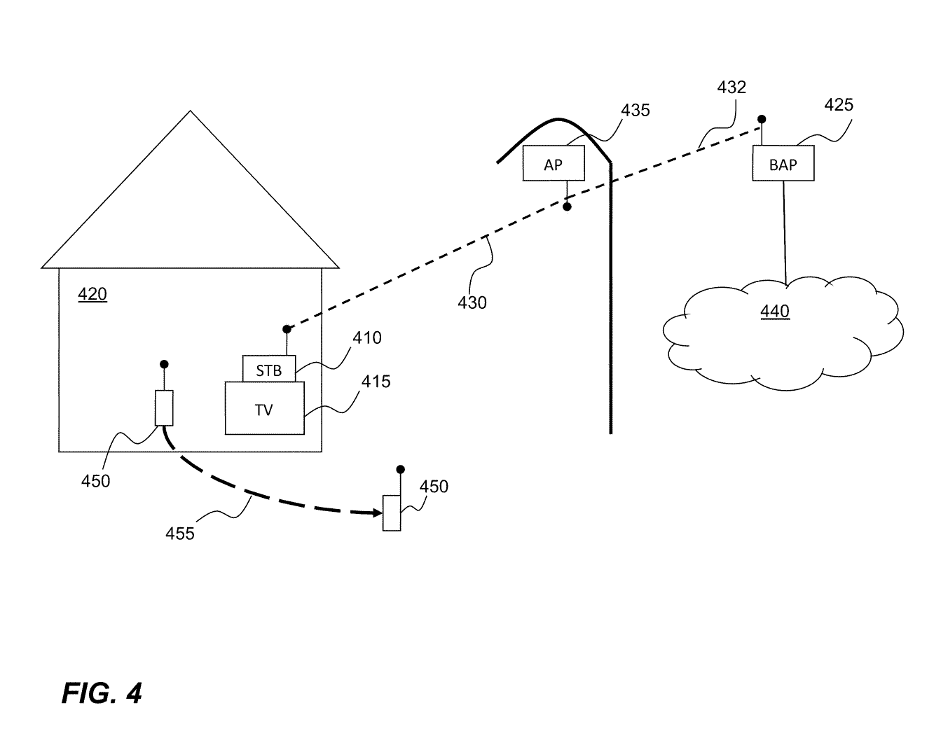

FIG. 4 shows a set top box in the context of a wireless ad hoc network. The set top box (STB) 410 is shown on top of a television 415. The set top box 410 may be connected to the television 415 by cables or through a wireless connection. Furthermore in some embodiments, the set top box 410 may be built into the television 415. The set top box 410 may receive broadcast signals from a satellite receiver (where multiple channels are encoded on waves received from an orbiting satellite) or the set top box 410 may receive broadcast signals through a cable television infrastructure from a cable television provider. While the following description emphasizes television broadcasts, it will be understood that broadcast signals may include video, audio (e.g., radio), pictures, or any other multimedia or computer content. Further, while the set top box 410 and television 415 are depicted together within a house 420, either or both may be located separately from one another and/or outside the house 420.

The set top box 410 may communicate with a backhaul access point (BAP) 425. This may include backchannel communications containing data to or from the set top box 410. The set top box 410 may communicate over a wireless connection 430 to an access point 435. It will be understood that the access point 435 may be any of the access points described above, including fixed access points installed in an area (such as on telephone pole, street light, or the like) to provide a spanning network for a MANET or other ad hoc network, as well as any subscriber device or other device that provides a radio and associated circuitry for participation in the ad hoc network. In one embodiment, the ad hoc network (which may be the MANET described above) may be formed exclusively of set top boxes installed in a community of nearby houses. Where the set top boxes are installed with sufficient spatial density and at least one such set top box includes an Internet connection or the like, the ad hoc network formed among the set top boxes may be sufficient to support backchannel services among the set top boxes without additional infrastructure.

In other embodiments, one or more dedicated access points such as an access point 435, which may be any of the access points described above, may optionally be installed in an area to improve geographic scope of the ad hoc network. The access point 435 may in turn communicate with the BAP 425 over a wireless connection 432, either directly, or through one or more other access points, set top boxes, and/or other subscriber devices. The access point 435 is shown by way of example and the set top box 410 may instead communicate directly with the BAP 425 if they are in close enough proximity. The access point 435 may be on a street pole or street light structure as diagrammatically represented in FIG. 4. Alternatively the access point 435 may be placed in any location convenient to the operation of the wireless ad hoc network.

The BAP 425 may communicate with an internetwork 440 such as the Internet, and may provide access to the internetwork 440 within an ad hoc network, such as the MANET described above, formed by the set top boxes, access points, and the like. The communication between the BAP 425 and the internetwork 440 may be by fiber termination 445, cable, Digital Subscriber Line (DSL), dial up, Integrated Services Digital Network (ISDN), or other any other suitable means for connecting to the internetwork 440. It will be appreciated that the BAP 425 may be a dedicated device that provides network connectivity for an ad hoc network, or the BAP 425 may be a set top box or other subscriber device that has an available connection to the internetwork 440. Thus in one aspect, a single house 420 with an Internet connection may serve as a BAP 425 for backchannel communications within an entire network of set top boxes 410 interconnected through an ad hoc network such as the MANET described above.

A mobile device 450 may communicate with the set top box 410. The mobile device 450 may operate as a subscriber device within the ad hoc network, and may communicate with the set top box 410 over the ad hoc network. It should be noted that the mobile device 450 may move from inside a house to outside a house (as indicated by arrow 455) and may still maintain wireless connection to the set top box 410. The mobile device 450 may also change connections to other set top boxes or other subscriber devices within the ad hoc network. In one aspect, the tuner for the set top box 410 may continue to transmit media to the mobile device 450, either directly or through the ad hoc network, to provide a roaming multimedia service to the subscriber device 450. Furthermore the mobile devices may receive from or send data to the set top box 410. This data may indicate or determine which broadcast channel for the set top box 410 to select. The data may also be in the form of internet communications relayed by set top box 410 to the mobile devices and may include web page or other Internet-derived information. In general the mobile device 450 may be any mobile electronic device including without limitation a cellular phone, personal digital assistant, netbook, laptop, camera, or other device that includes circuitry to operate as a node within the ad hoc network.

The backchannel communications among the wireless connections 430, 432 from the set top box 410 to the BAP 425 may include communications to authorize decoding of pay per view events, individual channels, groups of channels, and the like by the set top box 410. The backchannel communication may also or instead include customer viewing habits or any other communications that might usefully be supported between the set top box 410 and the internetwork 440 such as Internet browsing activity (which may be displayed on a television connected to a set top box), shopping, broadcast subscription choices, and so forth. Furthermore the backchannel communication may include data from the BAP 425 to the set top box 410 to provide firmware or other updates to the set top box 410, or to provide other customer-specific data such as viewer recommendations, weather storm warnings, governmental warnings, subscription information, and so forth.

In embodiments, a wireless ad hoc network such as the MANET described above may be utilized within the context of a digital broadcast satellite (DBS) system that provides a digital undifferentiated downlink to the set top box. The wireless ad hoc network may support extraction, decoding, and presentation of a user-selected channel from the set top box, such as by providing a backchannel for program authorization. It will be understood that a node, which may be the node 300 described above, that supports these communications may be provided as an external device connected to a set top box, e.g., through an Ethernet connection or other wired or wireless network interface, or as circuitry integrated into the set top box. In another aspect, the set top box may be configured to provide decoded video into IP transport, in effect using IP as transport for a video stream to other nodes, such as handsets; and the like.

A number of variations or implementations of set top boxes with wireless ad hoc networking are now described. These variations are meant to be illustrative, and not limiting in any way, as one skilled in the art will recognize other variations along the same theme.

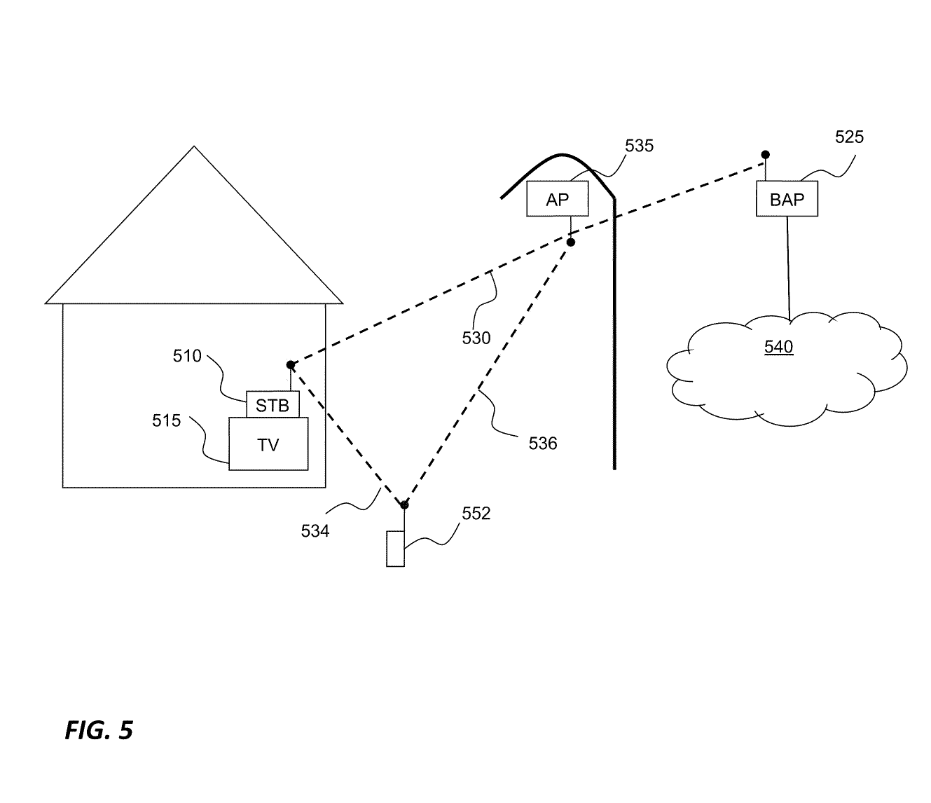

FIG. 5 shows a system where video is communicated from a set top box to a mobile device. A set top box 510 is shown on top of a television 515, although it will be readily appreciated that the set top box 510 may be positioned at any other convenient location or the set top box 510 may be integrated into the television 515.

As generally described above, the set top box 510 may communicate with a backhaul access point (BAP) 525, and the BAP 525 may communicate with an internetwork 540 such as the Internet. According to the principles of an ad hoc network as described above, communication links may be readily replaced as nodes are added to or removed from a network. Thus for example a communication link between the access point 535 and the set top box 510 may be re-routed across a second communication link 536 between the access point 535 and a mobile device 552, and across a third communication link 534 between the mobile device 552 and the set top box 510. Similarly, communications between the access point and the mobile device 552 may be routed through the communication link 530 and the third communication link, i.e., through the set to box 510. More generally, the ad hoc network may support routing among various nodes and devices, including re-routing as necessary or appropriate according to network conditions, device status, and so forth.

In one aspect, the set top box 510 may provide access to Internet protocol television (IPTV) services. These IPTV services may, in turn, be accessible from the mobile device 552. The set top box 510 may include circuitry to decrypt, authorize, and decode a video stream, which may then be pumped into the ad hoc network as IPTV for delivery to remote nodes. This variation may enable ‘slingbox’ functionality, where a user can watch the video delivered to their account from anywhere they have a remote subscriber device that is participating in the ad hoc network. In addition, programs may be selected from nodes with a software remote control that allows a user to select programs to view from their mobile device, PC screen, or other participating device.

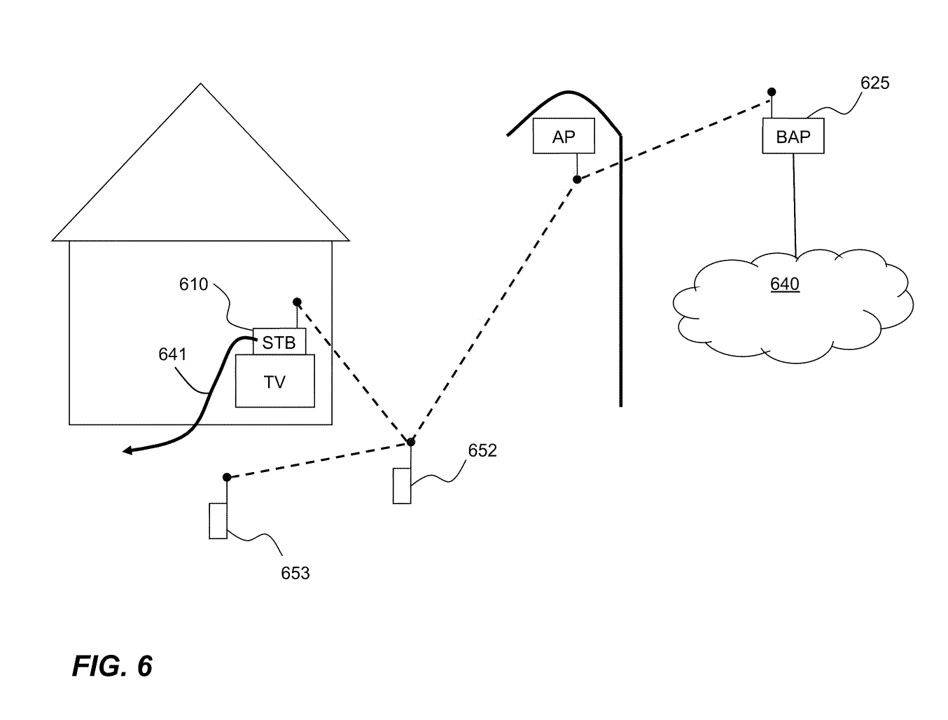

FIG. 6 shows a system where a cable service is the provider of a video source. The set top box 610 may receive broadcast signals through a cable 641 that establishes a communication link with a cable head end or the like from a cable television provider. The cable 641 may provide both broadcast video and Internet access.

In one aspect, the cable 641 may provide a backchannel for the set top box 610. In another one aspect, the set top box 610 may provide a backhaul access point for the ad hoc network by providing the communication link to other nodes in the ad hoc network. There may be other back haul access points, such as the backhaul access point 625, that similarly communicate with an internetwork 640 such as the Internet as generally described above. In this configuration, a mobile device such as the mobile device 652 may use either the set top box 610 or the backhaul access point 625 for backchannel communications and/or video. In addition, another mobile device 653 may use the mobile device 652 for both video and backchannel communications.

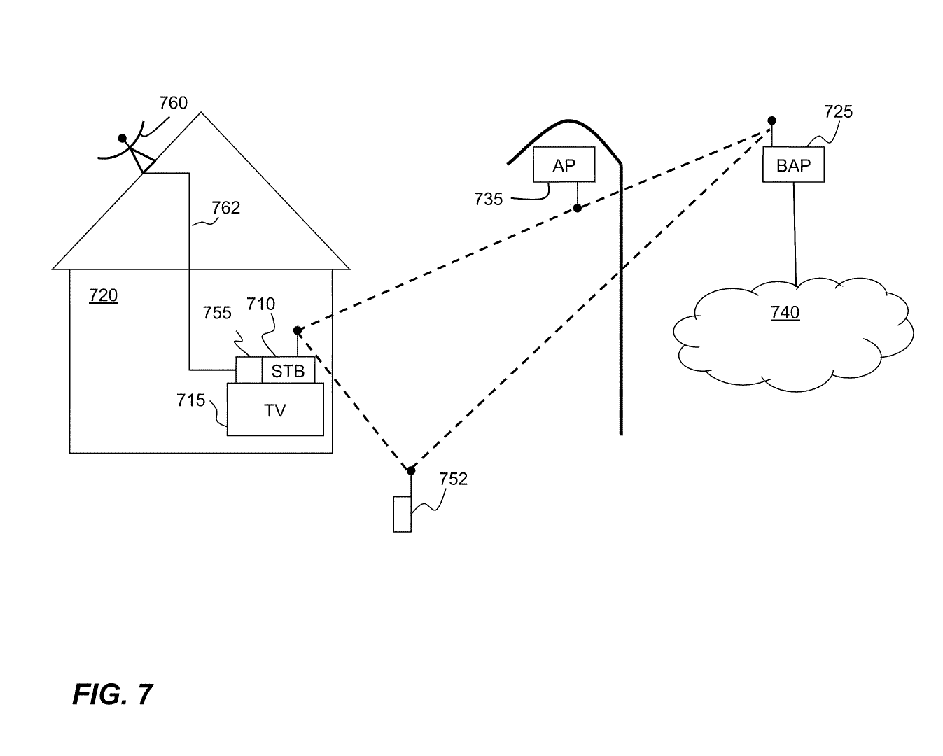

FIG. 7 shows a satellite broadcast system using a wireless ad hoc network for backchannel communications. In general, a set top box 710, which may be any of the set top boxes described above, may include a satellite receiver 755 that receives a signal from a satellite antenna 760 (such as a satellite dish or the like and any related passive or active circuitry). The satellite antenna 760 may receive a multi-channel broadcast or a direct broadcast satellite (DBS) signal from geosynchronous satellites and provide this signal to the satellite receiver 755 of the set top box 710 over a connection 762 such as a coaxial cable. The satellite antenna 760 may be attached to a roof of a house 720 as depicted, or more generally attached to any suitable pole or other structure. The satellite may receive C or Ku or other band transmissions from a satellite. In one aspect, the set top box 710 may include circuitry to operate as a node in a wireless ad hoc network as generally described above. In one aspect, the satellite antenna 760 may also include circuitry to operate as a node (such as the node 300 described above) in a wireless ad hoc network, and the set top box 710 may engage in backchannel communications through the wireless ad hoc network node of the satellite antenna 760. Regardless of the configuration, the set top box 710 may communicate with a backhaul access point 725 for backchannel communications as discussed above. In embodiments, a remote control may be used for remote access of the set top box, especially for controlling the set top box from across a room or other space.

The satellite receiver 755 may provide a tuner or the like to decode a single, user-selected channel from the satellite signal and processing circuitry to obtain and apply authorization to view the user-selected channel, along with output circuitry that provides a display signal for display by a television 715 or the like. In general, obtaining authorization may include communications with a remote source such as a satellite broadcasting center or other central office through an Internet backchannel or the like.

In general, backchannel communications sent through the backhaul access point 725 may include data communications with a central office associated with the satellite service provider, such as IP-based communications delivered through an Internet backchannel. Thus in one aspect a device disclosed herein includes a satellite receiver configured to receive a unidirectional broadcast satellite signal from a satellite antenna and to decode at least one channel of video broadcast content from the unidirectional broadcast satellite signal based upon an authorization obtained over an Internet backchannel; a wireless radio; and signal processing circuitry configured to operate the wireless radio to: discover an ad hoc network; join the ad hoc network as a node; and provide the Internet backchannel through the ad hoc network, whereby the authorization can be obtained. Various components of a wireless ad hoc network node such as the wireless radio and signal processing circuitry are described above, while other components such as the satellite receiver and tuner are described below

It will be appreciated that the set top box 710 may communicate with the backhaul access point 725 through a variety of different paths including through any number of fixed access points 735 and/or any number of mobile devices 752. In embodiments, a device may include a satellite receiver configured to receive a unidirectional broadcast satellite signal from a satellite antenna and to decode at least one channel of video broadcast content from the unidirectional broadcast satellite signal based upon an authorization obtained over an Internet backchannel; a wireless radio; and signal processing circuitry configured to operate the wireless radio to: discover an ad hoc network; join the ad hoc network as a node; and provide the Internet backchannel to the tuner through the ad hoc network, whereby the tuner can obtain the authorization. The signal processing circuitry may be further configured to operate the node as one or more of a source and a destination of peer-to-peer traffic within the ad hoc network. In embodiments, the signal processing circuitry may be configured to communicate over the ad hoc network to authorize the tuner to decode the at least one channel of video broadcast content. The signal processing circuitry may be further configured to deliver broadband Internet connectivity to a user from the ad hoc network. In embodiments, one or more of the satellite receiver, the wireless radio, and the signal processing circuitry may be integrated into a set top box with a connector for delivering the at least one channel of video broadcast content to a television. In embodiments, the connector may include one or more of an RF connector, a composite video connector, an S-video connector, a component video connector, a D-Sub connector, a Digital Visual Interface connector, a High Definition Multimedia Interface connector, and an IEEE 1394 connector.

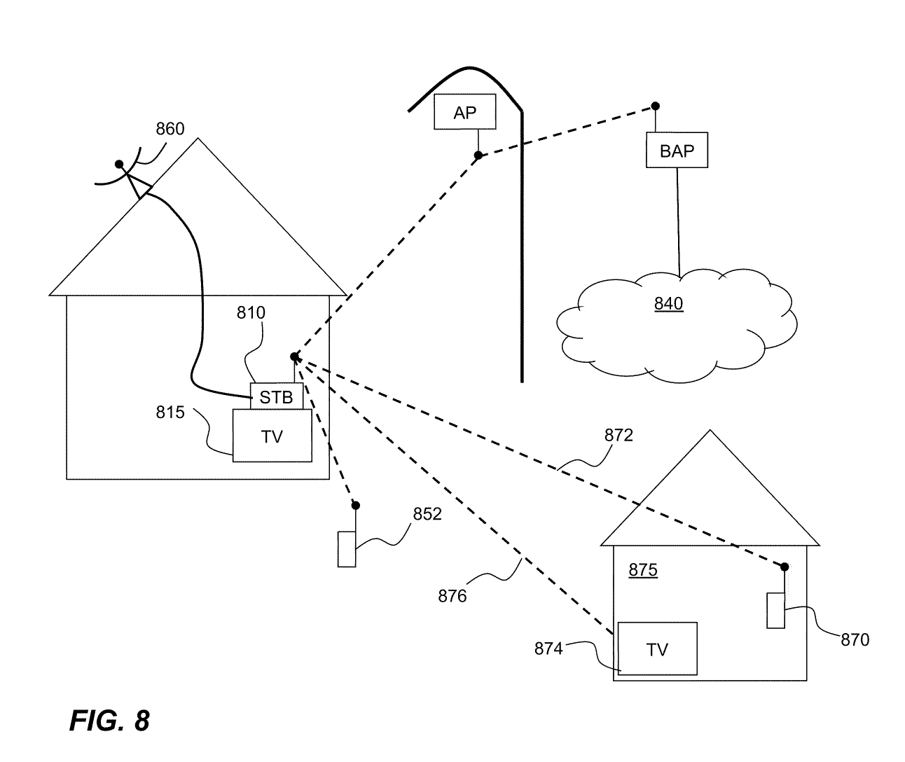

FIG. 8 shows a set top box that sends video over a wireless network to a neighboring television. In general, the set top box 810 operates with the satellite antenna 860 and a backchannel to an internetwork 840 to provide a channel for display on the television 815, all as described above. A mobile device 852 may operate as a node in an ad hoc network with the set top box 810, and may receive a stream of decoded video from the set top box. Any number of additional devices, such as a mobile device 870 or a television in a neighboring house 875 may also or instead receive decoded video. In one aspect, the set top box 810 may contain a satellite receiver with a single tuner, so that only a single channel can be decoded and transmitted to other nodes. In this case, any device receiving video (or audio or other broadcast media) from the set top box 810 will receive the same channel. In another aspect, the set top box 810 may include multiple, independent tuners so that the other nodes can access different channels through the set top box 810. In another aspect, one or more of the nodes can send data to the set top box 810 such as channel selection control signals and/or receive data from the set top box 810 such as channel selection options. Thus in one aspect a mobile device such as a cellular phone or portable wireless device with access to the ad hoc network may be used as a channel controller or provide other remote control functions directed at the set top box 810. In another aspect, the set top box 810 may provide general Internet connectivity (from the internetwork 840) to other devices for web browsing or the like.

In embodiments, the delivery of the satellite or cable multichannel broadcast signals may be transformed into IPTV for a community. The transformation of a broadcast channel into IPTV may be performed within the set top box 810 or at another device connected to the wireless ad hoc network. Thus in one aspect the wireless ad hoc network may be the IPTV delivery transport for a DBS franchise, which may minimize the cost of individual dishes (i.e. one dish may serve a plurality of households). In addition, this permits the use of a precision dish installation, providing a single point for maintenance. The wireless ad hoc network may support delivery of programming, Internet access, backchannel communications, value added services, and the like. In embodiments, a device may be provided with circuitry for a node in the wireless ad hoc network, such as the node 300 described above, along with a video output for authorized, decoded video. Depending on the complexity of the central office deployment, the system may support video on demand (VOD) applications, time-shifting applications (e.g. local storage in the set top box 810), and any other viewing options that can be deployed or controlled through a set top box 810. In one aspect, the wireless ad hoc network may be optimized for delivery of IPTV.

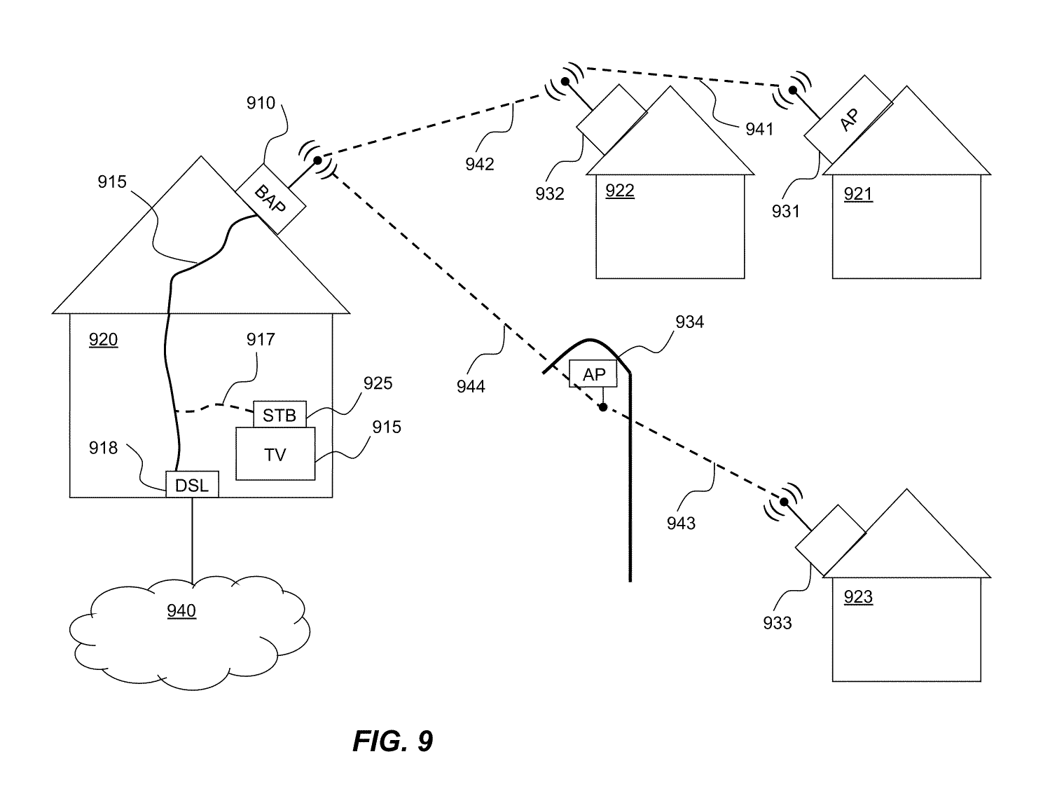

FIG. 9 shows a system for set top box backchannel communication. A backhaul access point (BAP) 910 is shown connecting to an internetwork 940 such as the Internet through a network interface 918, which may include a digital subscriber line modem, a cable modem, an ISDN modem, a dial up modem, or other modem or other means of connecting to a service provider. The backhaul access point 910 may connect to the internetwork 940 directly through one or more cables 915 to the network interface 918. A local set top box 925 may also use the network interface 918 for backchannel communications, or may provide data network connectivity from the network interface 918 to the backhaul access point 910 through a connection 917. More generally, a variety of configurations and deployments may be used within a house 920 to take advantage of the combined functionality of a wireless ad hoc network on one hand and a data network connection on the other hand. In embodiments, the set top box 925 may use the backhaul connection and may include signal processing circuitry further configured to operate as a backhaul access point in the ad hoc network.

The backhaul access point 910 may also provide a backchannel for multiple houses using a wireless ad hoc network. For example, each house 921, 922, and 923 may have a set top box, along with a television for viewing broadcast content. Each house 921, 922, 923 may also have a satellite antenna that receives multi-channel broadcast through a direct broadcast satellite (DBS) communication or the like. Each house may also have include a node for participating in the wireless ad hoc network, such as a first access point 931 for the first house 921, a second access point 932 for the second house 922, and a third access point 933 for the third house 923. Each access point 931, 932, 933 may receive information from the backhaul access point 910, or from another access point within the wireless ad hoc network. In this manner, a collection of houses with set top boxes may opportunistically identify and use sources for backchannel communications from anywhere within the wireless ad hoc network. Thus for example where a particular path for backchannel communications is compromised by a power down, fault, loss of data network connectivity at the backhaul access point, traffic congestion within the wireless ad hoc network, or any other reason, other backchannel resources within the wireless ad hoc network may be identified and used. The backchannel communications may include pay per view authorizations, customer viewing habits, broadcast program changes, firmware updates, viewing recommendations, and other data communications between the set top boxes and the internetwork 940.

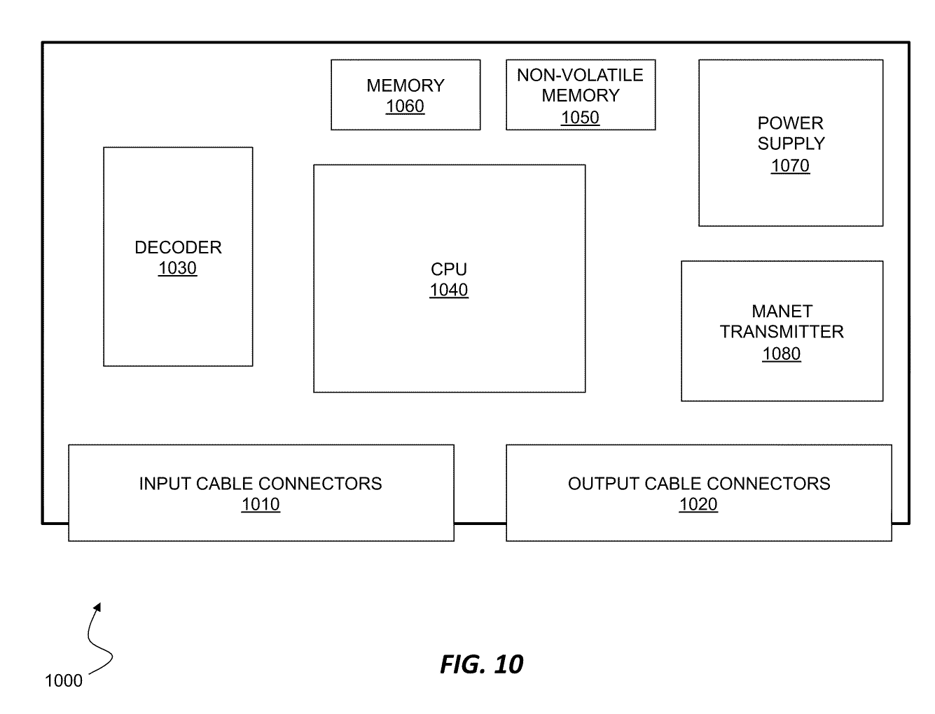

FIG. 10 is a block diagram of a set top box 1000 which may be used in the context of a wireless ad hoc network. The set top box 1000 may include a power supply 1070 for providing proper voltage and currents to the various components of the set top box 1000. The power supply 1070 may include a line cord that plugs into a wall which supplies 110V or 220V AC or similar input power to the set top box 1000. Alternatively, the power supply 1070 may include a battery which may be replaced on a periodic basis or which may provide power during a temporary power outage. The power supply 1070 may include a set of solar cells or other alternative power source that may be used instead of or as a supplement to a line voltage from a power cord. The power supply 1070 may also or instead obtain power from a cable or Ethernet input. The power supply 1070 may provide voltage and current as needed to a CPU 1040, a decoder 1030, a memory 1060, a non-volatile memory 1050, a MANET transmitter 1080, and other components of the set top box 1000.

Input cable connections 1010 may include ports for use by Ethernet cables, coaxial cable inputs for connection to a cable television provider, a power cord connection, or other types of input connections as beneficial to the various components and function of the set top box and as desired by the television providers. The input cable connectors 1010 may further include connections for a satellite antenna or satellite dish. In embodiments, the satellite dish may be attached to or be component of the set top box 1000.

Output cable connections 1020 may include coax cable for connection to a television, digital video recorder, video tape recorder or other device used for displaying or recording video and audio signals. The output cable connections 1020 may further include power ports for attachment to and powering of other equipment near the set top box 1000. Output cable connections 1020 may also include video or audio output ports.

CPU 1040 may be a central processing unit or may be a signal processor or other type of device used in processing. The CPU 1040 may perform analysis of the signals coming into the set top box 1000 on cable connectors 1010. The CPU 1040 may modify the signals being driven from the set top box 1000 through output cable connectors 1020. The CPU 1040 may store information, such as temporary instructions or data in memory 1060. The CPU 1040 may further store information in the non-volatile memory 1050. The CPU 1040 may work in concert with Decoder 1030 to obtain and perform authorization of certain video or other material from the set top box 1000.

Memory 1060 may contain data or instructions relevant to the set top box 1000 operation or the decoding of certain channels or programs. The non-volatile memory 1050 may contain information needed at time of power up for the set top box 1000. The non-volatile memory 1050 may be used to store information that is brought in as part of a firmware update for the set top box 1000.

The decoder 1030 may analyze signals from the input cable connectors 1010 to tune, decode, demodulate, or otherwise make the signals usable to televisions or other devices attached to or connected with the set top box 1000. The decoder 1030 may include a satellite receiver, cable television receiver, or any other circuitry to select individual channels from a multi-channel broadcast, obtain authorization to view the selected channel or channels, and decode the selected channel or channels from the broadcast for display on a television or other view screen. The decoder may use authorization information, such as that associated with a pay per view authorization or that associated with a subscribed channel, to authorize and decode input signals. The decoded signals are then provided to the output cable connectors 1020 or the MANET transmitter 1080 to allow attached devices to use the decoded signals.

MANET transmitter 1080 may communicate with other devices as part of a wireless ad hoc network. Televisions may be wirelessly attached to the set top box 1000 through the MANET transmitter 1080. A set top box backchannel to an internetwork, such as the Internet, may be accomplished through the MANET transmitter 1080. Furthermore, firmware updates may be downloaded from the Internet via the MANET transmitter 1080. Additionally, mobile television, internet access, voice over internet protocol (VOIP), and other capabilities may be enabled through the MANET transmitter. Further, any mobile broadband routable internet (MBRI) capability may be implemented through the set top box 1000 with a MANET transmitter 1080. It should also be understood that while a MANET transmitter 1080 is shown as part of a set top box 1000, it is possible for a set top box 1000 to have a separate the MANET transmitter 1080 as an attachment which may be connected through the input 1010 and output cable connections 1020.

In some embodiments, circuitry of the set top box 1000 may be incorporated as part of a television set and therefore be one contiguous unit rather than have separate television and the set top box units.

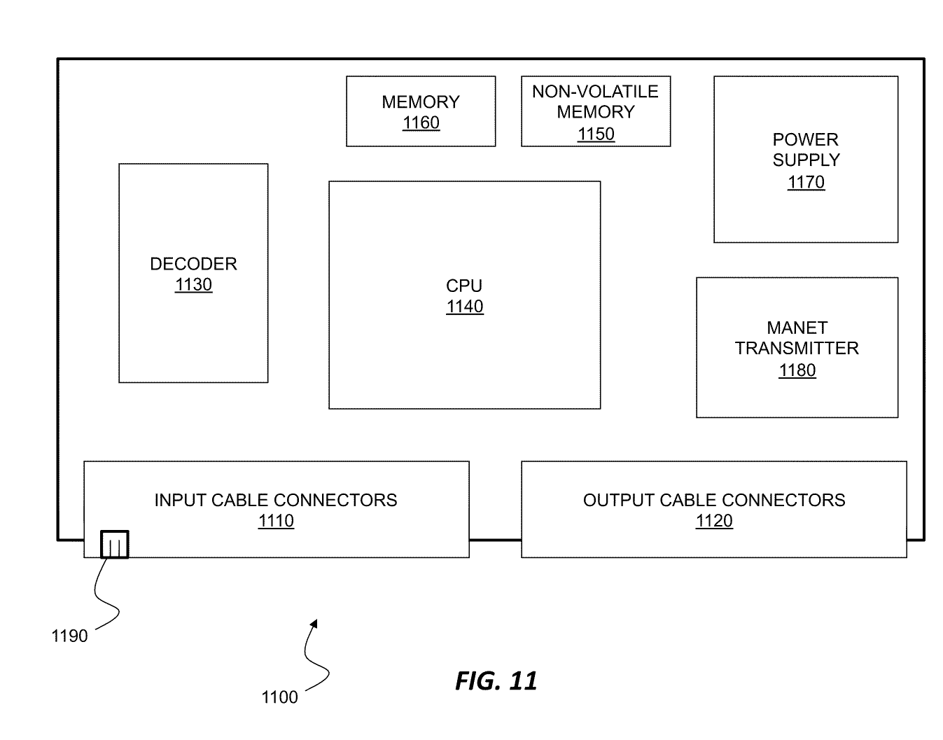

FIG. 11 is a block diagram of a set top box 1100 with a telephone connection port. This set top box 1100 which may be used in the context of a wireless ad hoc network. The set top box 1100 may include a power supply 1170 for providing proper voltage and currents to the various components of the set top box. The power supply 1170 may include a line cord that plugs into a wall which supplies 110V or 220V AC or similar input power to the set top box 1000. Alternatively, a power supply 1170 may include a battery which may be replaced on a periodic basis or which may provide power during a temporary power outage. The power supply 1170 may include a set of solar cells or other alternative power source which may be used instead of or supplement a line voltage from a power cord. The power supply 1170 may also obtain power from a cable or Ethernet input. Power supply 1170 may provide voltage and current as needed to the CPU 1140, decoder 1130, memory 1160, non-volatile memory 1150, MANET transmitter 1180, and other components of the set top box 1100.

Input cable connections 1110 may include ports for use by Ethernet cables, coaxial cable inputs for connection to a cable television provider, a power cord connection, or other types of input connections as beneficial to the various components and function of the set top box and as desired by the television providers. The input cable connections 1110 may further include phone connection port or ports 1190. A backhaul access point may be obtained by using a telephone connection port to accomplish dial up internet access or by Integrated Services Digital Network (ISDN), again using a telephone connection port.

Output cable connections 1120 may include coax cable for connection to a television, digital video recorder, video tape recorder or other device used for displaying or recording video and audio signals. The output cable connections 1120 may further include power ports for attachment to and powering of other equipment near the set top box 1100. Output cable connections 1020 may also include video or audio output ports.

CPU 1140 may be a central processing unit or may be a signal processor or other type of device used in processing. The CPU 1140 may perform analysis of the signals coming into the set top box 1100 on the cable connectors 1110. The CPU 1140 may modify the signals being driven from the set top box 1100 through the output cable connectors 1120. The CPU 1140 may store information, such as temporary instructions or data in memory 1060. The CPU 1140 may further store information in non-volatile memory 1150. The CPU 1040 may work in concert with the decoder 1130 to obtain and perform authorization of certain video or other material from the set top box 1100.

Memory 1160 may contain data or instructions relevant to the set top box 1100 operation or the decoding of certain channels or programs. Non-volatile memory 1150 may contain information needed at time of power up for the set top box 1100. The non-volatile memory 1150 may be used to store information that is brought in as part of a firmware update for the set top box 1100.

Decoder 1030 may analyze signals from the input cable connectors 1110 to decode, demodulate, or otherwise make the signals usable to televisions or other devices attached to or connected with the set top box 1100. The decoder may use authorization information, such as that associated with a pay per view authorization or that associated with a subscribed channel, to decode input signals. The decoded signals are then provided to the output cable connectors 1020 or the MANET transmitter 1180 to allow attached devices to use the decoded signals.

MANET transmitter 1180 may communicate with other devices as part of a wireless ad hoc network. Televisions may be wirelessly attached to the set top box 1100 through MANET transmitter 1180. A set top box backchannel to an internetwork, such as the Internet, may be accomplished through the MANET transmitter 1180. Furthermore, firmware updates may be downloaded from the Internet via the MANET transmitter 1180. Additionally, mobile television, internet access, voice over internet protocol (VOIP), and other capabilities may be enabled through the MANET transmitter. Further, any mobile broadband routable internet (MBRI) capability may be implemented through the set top box 1100 with a MANET transmitter 1180. It should also be understood that while a MANET transmitter 1180 is shown as part of a set top box 1100, it is possible for a set top box 1100 to have a separate MANET transmitter 1180 as an attachment which may be connected through the input 1010 and output cable connections 1120.

In some embodiments, the set top box 1100 circuitry may be incorporated as part of a television set and therefore be one contiguous unit rather than have separate television and the set top box units.

In embodiments, the set top box may participate as a fully functional peer on an MBRI network, permitting moderate bandwidth up and down link for bundled services. In this variation the application layer may be enabled, may include bundled services (e.g. VoIP), may include terminal adaptor functionality out of the set top box (e.g. telephone ports) for direct connection to home telephone wiring, and the like. In embodiments, the device may be a CAP, in which case mobile subscriber devices may be the portable home telephones.

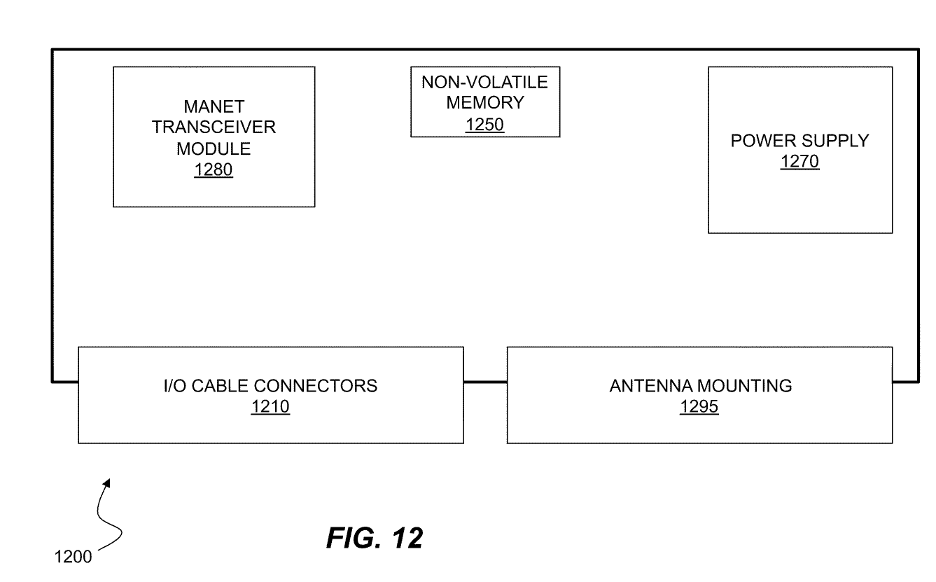

FIG. 12 is a block diagram of a roof mount fixture 1200 for mobile broadband routable internet (MBRI). Such a roof mount fixture may function as part of a MANET to enable MBRI. In embodiments, a roof mount fixture 1200 may be connected to a set top box inside a house to provide the set top box features to other nodes on the MANET.

The roof mount fixture 1200 may include a power supply 1270 for providing proper voltage and currents to the various components of the roof mount fixture. In embodiments, power may be obtained through a data cable using a Digital Satellite Equipment Control (DiSEqC) standard. Alternatively power may be obtained using a 100BASE-T standard connection or other over Ethernet power or other data type cable power technology. In embodiments, the power supply 1270 may include a line cord that connects into house electrical wiring which supplies 110V or 220V AC or similar input power to the roof mount fixture 1200. Alternatively, a power supply 1270 may include a battery which may be replaced on a periodic basis or which may provide power during a temporary power outage. The power supply 1270 may include one or more solar cells or other alternative power source which may be used instead of or supplement a line voltage from a power cord. The power supply 1270 may also obtain power from a cable or Ethernet input. The power supply 1270 may provide voltage and current as needed to the memory 1260, non-volatile memory 1250, MANET transceiver module 1280, and other components of roof mount fixture 1200.

Input and output (I/O) cable connections 1210 may include ports connections to an in-house set top box, an in-house backhaul access point (BAP), Ethernet cables, a power cord connection, or other types of input connections as beneficial to the various components and function of the roof mount fixture.

Non-volatile memory 1250 may contain information needed at time of power up for the roof mount fixture 1200. The non-volatile memory 1250 may be used to store information as that is brought in as part of a firmware update for roof mount fixture 1200.

MANET transceiver module 1280 may communicate with other devices as part of a wireless ad hoc network. A set top box backchannel to an internetwork, such as the Internet, may be accomplished through the MANET transceiver module 1280. Furthermore, firmware updates may be downloaded from the Internet via the MANET transceiver module 1080.

The antenna mounting 1295 may include a bracket for mounting an antenna for transmitting and receiving wireless ad hoc network signals. In embodiments, the mounting may include a bracket for attaching the roof top fixture 1200 to the roof of a house. In embodiments, the mounting may including cabling and connectors to reach an antenna mounted near the roof top fixture 1200. In embodiments, the mounting may include a satellite dish.

In embodiments, the MANET transceiver, associated circuitry and attached devices, such as a set top box, may participate as a fully functional peer on the MBRI network (such as permitting up and down link for low to moderate bandwidth Internet services, web access, and possibly only best effort quality of service (QoS)). In embodiments, depending on the design, browsing may be possible on a regular PC connected to wifi or LAN, and routed to a television video display as an integrated home package.

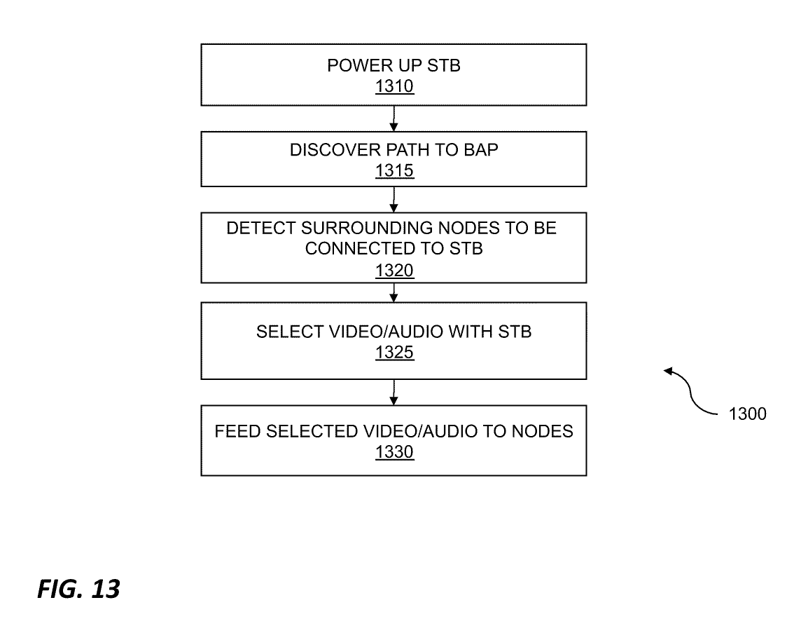

FIG. 13 is a flowchart for set top box transmission of video. Video may be communicated over a wireless ad hoc network by using various technical features.

The process 1300 begins by powering up the set top box (step 1310). Power up may be accomplished by manually switching on the set top box or it may be that the set top box is on a timer and switches on automatically. Alternatively a signal to “wake up” the set top box may be communicated from another processor or even from the cable or satellite provider causing the set top box to power up. Included in the set top box power up may be a boot process where firmware, non-volatile memory, disk, or other storage may be read which does not lose its data when the set top box is powered down. Upon power up the CPU, signal processor, or other processing unit may perform a diagnostic self check to verify that it and other components within the set top box are operating correctly. In embodiments, the process may include a method for wireless communication of video with a fixture on a wireless ad hoc network. The fixture may be a set top box.

In step 1315, a path from the set top box to a backhaul access point may be determined. The path may be through an Ethernet port, a cable service connection, or a dial up connection. Alternatively, the path may be through a MANET transmitter in the set top box, across a wireless ad hoc network. In embodiments, the set top box may communicate over the wireless ad hoc network to a backhaul access point connected to an internetwork.

In step 1320, nodes surrounding the set top box may be detected. These nodes may be connected with the set top box via the wireless ad hoc network. A selection criteria may be followed where only those nodes which will access the set top box features may be allowed access to the set top box. Other nodes which are reachable within the wireless ad hoc network but will not use features of the set top box may be restricted from access to the set top box.

In step 1325, the set top box may select video or audio, as in the case of satellite radio for example, for transmission to surrounding nodes which are connected to the set top box via the wireless ad hoc network. The process may include receiving a multi-channel broadcast from a signal source and may include television signals, which may be accomplished by receiver circuitry. The process may further include selecting a video signal from the multi-channel broadcast, which may be accomplished by tuner circuitry. In embodiments, selecting the video signal may include obtaining authorization to view the selected video signal through a data network. The multi-channel broadcast may be communicated through the Internet, by cable to the set top box, or by a satellite. The selection may be by selection of a channel from a multi-channel broadcast from a signal source to the set top box. The selection at the set top box may be performed by a remote control which accesses the set top box. The selection may be by having a node in the wireless ad hoc network, such as a node to which the set top box is transmitting video, transmit a signal to the set top box indicating the desired channel for selection.

In step 1330, the selected video or audio may be fed to the nodes in the wireless ad hoc network which are connected to the set top box. The selected video may be fed to a single node which is interested in the video or it may be transmitted so that multiple nodes may receive and display the video which the set top box transmits. In embodiments, the process may include transmitting the video signal which was selected from the fixture or set top box to a node in the wireless ad hoc network, which may be accomplished with transmitter circuitry. In embodiments, the node may be a mobile device and the process may include handing off seamlessly the mobile device from the set top box to an ad hoc network access point, wherein the mobile device continues to receive video. In embodiments, the node may be a mobile device and the process may include handing off seamlessly the mobile device from the set top box to a second set top box, wherein the mobile device continues to receive video. In further embodiments, the node may relay the video signal to a second node in the wireless ad hoc network. Alternatively, a second node may relay video signal to a third node in the wireless network. The transmitting may include mobile broadband routable internet data. It will be understood that the set top box may decode multiple channels and that one channel may be fed to one or more nodes while a second channel may be fed to one or more other nodes. In some embodiments it may be possible for two videos to be displayed simultaneously, such as a picture within a picture, in which case one node may receive multiple video signals from the set top box. In further embodiments, the process may include transmitting the video signal which was selected by the set top box to a television attached to the wireless ad hoc network. In other embodiments, the process may include communicating data packets, which may be accomplished by communicating circuitry, with the Internet by one or more mobile devices attached to the wireless ad hoc network through the set top box.

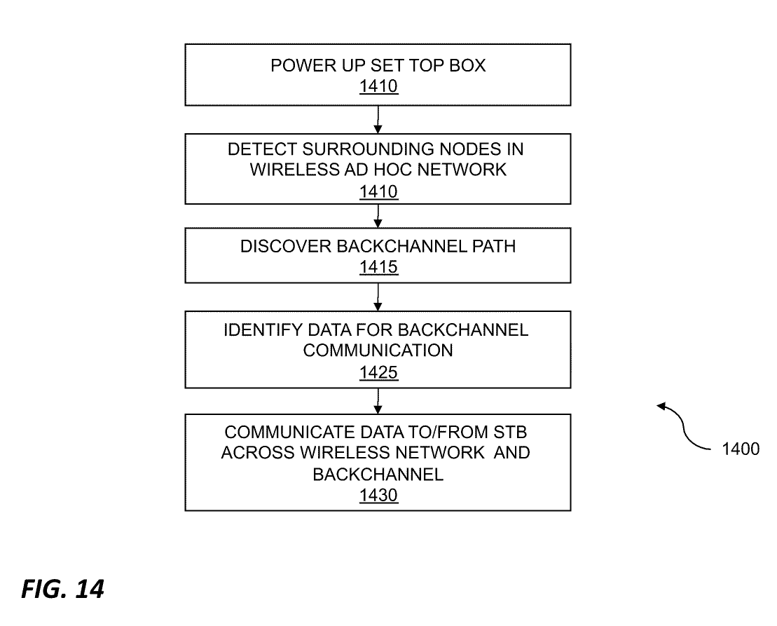

FIG. 14 is a flowchart for wireless backchannel communication by a set top box. This process includes a method for operating a backhaul access point. The process 1400 begins by powering up the set top box (step 1410). Power up may be accomplished by manually switching on the set top box or it may be that the set top box is on a timer and switches on automatically. Alternatively a signal to “wake up” the set top box may be communicated from another processor or even from the cable or satellite provider causing the set top box to power up. Included in the set top box power up may be a boot process where firmware, non-volatile memory, disk, or other storage may be read which does not lose its data when the set top box is powered down. Upon power up the CPU, signal processor, or other processing unit may perform a diagnostic self check to verify that it and other components within the set top box are operating correctly. In embodiments, the process may begin by observing one or more neighbor nodes in a wireless ad hoc network and identifying a set top box attached to one of the one or more neighbor nodes. In embodiments, the one or more neighbor nodes which are observed may be updated as new nodes enter the wireless ad hoc network.

In step 1410, nodes surrounding the set top box in a wireless ad hoc network may be detected. These nodes may be connected with the set top box via the wireless ad hoc network. A selection criteria may be followed where only those nodes which will access the set top box features may be allowed access to the set top box. Other nodes which are reachable within the wireless ad hoc network but will not use features of the set top box may be restricted from access to the set top box.

In step 1415, a backchannel path to a backhaul access point may be discovered. This backchannel path may provide a means for communicating with an internetwork such as the Internet. The backchannel path will typically be across a wireless ad hoc network and may include mobile broadband routable internet access. There may be a television attached to a set top box where the set top box needs to communicate with the satellite service or cable service provider. The set top box may take advantage of a surrounding wireless network and may opportunistically use the wireless ad hoc network to communicate the backchannel data and to reach a backhaul access point (BAP). By “opportunistically” it can be understood to mean that a MANET or other wireless ad hoc network may exist. A set top box may be turned on or may already be on and need to perform backchannel communication. The set top box may detect the existence of the wireless ad hoc network and send data to the BAP even though no formal or rigorous communications packets were previous exchanged. In embodiments, the backchannel data may travel to the backhaul access point through a second set top box.

One example of such an opportunistic communication would be that a house in a neighborhood may have a backhaul access point inside it where backchannel data may travel across one or more of a group comprising cable internet service, digital subscriber line (DSL) service, and dial up internet connection. This house may have a set top box and television inside it but it may also just have a BAP and a means for connecting the BAP to the wireless ad hoc network. Another house in the neighborhood may have a set top box and television attached to the set top box. This second house may not have an internet connection and have no BAP. The set top box in the second house may have need to communicate data through a back channel. Such backchannel data communication may include set top box firmware updates, pay per view authorizations, customer account information, information on customer viewing habits, promotional information, viewing recommendations, or other information exchanges. In embodiments, the process may include updating firmware on the set top box with the data which was delivered. The set top box in the second house may have a MANET transmitter and may look to detect surrounding wireless ad hoc networks which are available. Whatever surrounding wireless ad hoc networks are available may then be used to transmit the needed backchannel communications. In this manner the set top box in the second house may take advantage of surrounding wireless ad hoc networks and opportunistically use them to transmit backchannel communications. It can be understood that surrounding wireless ad hoc networks could change regularly and that different networks and network structures could exist at different times for opportunistic wireless ad hoc network communications. There may be multiple BAPs which are reachable from the set top box in the second house. One or more of these multiple BAPs may be powered down, requiring the use of a different BAP and different wireless ad hoc network structure for backchannel communication. Likewise encryption protocols could change, making certain BAPs inaccessible from the set top box in the second house. Further, other nodes may join or depart from a MANET, causing a usable path to a BAP to change. Thus, in various manners, the wireless ad hoc networks may change but by opportunistic usage the set top box may identify and use a path for backchannel communications.

In step 1425, data may be identified for backchannel communication. This data may be information for upload from the set top box to the Internet and ultimately to the cable or satellite service provider. This upload data may include pay per view authorization, information obtained from a keyboard connected to the set top box, customer viewing habit information, or other data. The data for backchannel communication may be information for download from the cable or satellite service provider to the set top box such as firmware updates for the set top box, viewing recommendations, or other data. In embodiments, the process may include receiving backchannel data from the set top box, the backchannel data including an Internet destination address. In embodiments, the process may include receiving data from an internetwork addressed to the set top box.

In step 1430, the data which was identified for communication across the backchannel may be communicated to or from the set top box. The data may be in the form of a single stream or it may be broken into packets for communication. In embodiments, the process may include forwarding the backchannel data to an internetwork for routing to the Internet destination address. In embodiments, the process may include delivering the data to the one of the one or more neighbor nodes attached to the set top box.

Throughout this disclosure and elsewhere, references to industry standards such as those published by the Internet Engineering Task Force and the Institute of Electrical and Electronics Engineers provide non-limiting, illustrative examples for enabling one of ordinary skill in the art to practice what this specification describes. It will be appreciated that a variety of functional equivalents to the disclosed industry standards exist or are possible. All such equivalents are intended to fall within the scope of this specification.

It will be understood that for each flow chart, the depicted steps are provide for purposes of illustration and explanation only, and that the steps may be modified, omitted, or re-ordered, and other steps may be added, without departing from the scope of this disclosure. While the foregoing drawings and description set forth functional aspects of the disclosed systems, no particular arrangement of software and/or hardware for implementing these functional aspects should be inferred from these descriptions unless explicitly stated or otherwise clear from the context, and all such arrangements of software and/or hardware are intended to fall within the scope of this disclosure.

The methods or processes described herein may in general be realized as a computer program product embodied in a computer readable storage medium that performs the corresponding steps, or as a device including a processor, memory and/or other circuits configured through programming or the like to perform the steps described. Traditionally, a computer program consists of a finite sequence of computational instructions or program instructions. It will be appreciated that a programmable apparatus can receive such a computer program and, by processing the computational instructions thereof, produce a further technical effect. Regardless of the type of computer program or computer involved, a computer program can be loaded onto a computer to produce a particular machine that can perform any and all of the depicted functions. This particular machine provides a means for carrying out any and all of the depicted functions.

A processor or programmable apparatus as described herein may include one or more microprocessors, microcontrollers, embedded microcontrollers, programmable digital signal processors, programmable devices, programmable gate arrays, programmable array logic, memory devices, application specific integrated circuits, quantum computing devices, optical computing devices, or any other combination of discrete and/or programmable electronic devices, which can be suitably employed or configured to process computer program instructions, execute computer logic, store computer data, and so on. A computer or processor as described herein may include a general purpose computer, a special-purpose computer, a programmable data processing apparatus, a processor, and so on as well as any combination of the foregoing. Signal processing circuitry may in general include any of the foregoing, as well as any other analog and/or digital circuitry suitable for predetermined or programmable operation.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium include a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may more generally include any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, it will be understood that the depicted elements and the functions thereof may be implemented as parts of a monolithic software structure, as standalone software modules, or as modules that employ external routines, code, services, and so forth, or any combination of these. At the same time execution of the depicted processes may be single or multi-threaded and/or configured for execution on one or more processors. All such implementations are within the scope of the present disclosure.

In view of the foregoing, it will be appreciated that elements of the block diagrams and flowchart illustrations support combinations of means for performing the specified functions, combinations of steps for performing the specified functions, computer executable code for performing the specified functions, and so on.

It will be appreciated that computer executable code may include may include any program instructions or the like. A variety of languages for expressing computer program instructions are possible, including without limitation structured programming languages such as C, C++, Java, JavaScript, assembly language, Lisp, and so on. Such languages may also or instead include assembly languages, hardware description languages, database programming languages, functional programming languages, imperative programming languages, structured programming languages, object-oriented programming languages, scripting languages, high-level languages, low-level languages, and so on. In some embodiments, computer program instructions can be stored, compiled, or interpreted to run on a computer, a programmable data processing apparatus, a heterogeneous combination of processors or processor architectures, and so on. Without limitation, embodiments of the present invention can take the form of web-based computer software, which includes client/server software, software-as-a-service, peer-to-peer software, or the like.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

1. A method for operating a backhaul access point comprising:
observing one or more neighbor nodes in a wireless ad hoc network;
identifying a set top box attached to one of the one or more neighbor nodes;
receiving backchannel data from the set top box, the backchannel data including an Internet destination address; and
forwarding the backchannel data to an internetwork for routing to the Internet destination address.

2. (canceled)

3. The method of claim 1 wherein the backchannel data includes customer account information.

4-5. (canceled)

6. The method of claim 1 wherein the backchannel data travels across one or more of a group comprising cable internet service, digital subscriber line (DSL) service, and dial up internet connection.

7. The method of claim 1 wherein the backchannel data travels to the backhaul access point through a second set top box.

8. The method of claim 1 wherein the set top box opportunistically uses the wireless ad hoc network to communicate the backchannel data.

9. (canceled)

10. A node in a wireless network comprising:
a radio for operating within the wireless network;
a backhaul access point connected to the radio;
a processor programmed to: observe one or more neighbor nodes in the wireless network; identify a set top box attached to one of the one or more neighbor nodes; receive backchannel data from the set top box, the backchannel data including an Internet destination address; and forward the backchannel data to an internetwork for routing to the Internet destination address.

11. (canceled)

12. The node of claim 10 wherein the backchannel data includes customer account information.

13-14. (canceled)

15. The node of claim 10 wherein the backchannel data travels across one or more of a group comprising cable internet service, digital subscriber line (DSL) service, and dial up internet connection.

16. The node of claim 10 wherein the backchannel data travels to the backhaul access point through a second set top box.

17. The node of claim 10 wherein the set top box opportunistically uses the wireless network to communicate the backchannel data.

18. (canceled)

19. A computer program product embodied in a computer readable medium that, when executed, operates a backhaul access point by performing the steps of:
observing one or more neighbor nodes in a wireless ad hoc network;
identifying a set top box attached to one of the one or more neighbor nodes;
receiving backchannel data from the set top box, the backchannel data including an Internet destination address; and
forwarding the backchannel data to an internetwork for routing to the Internet destination address.

20. (canceled)

21. The computer program product of claim 19 wherein the backchannel data includes customer account information.

22-23. (canceled)

24. The computer program product of claim 19 wherein the backchannel data travels across one or more of a group comprising cable internet service, digital subscriber line (DSL) service, and dial up internet connection.

25. The computer program product of claim 19 wherein the backchannel data travels to the backhaul access point through a second set top box.

26. The computer program product of claim 19 wherein the set top box opportunistically uses the wireless ad hoc network to communicate the backchannel data.

27-103. (canceled)

104. A device comprising:
a satellite receiver configured to receive a unidirectional broadcast satellite signal from a satellite antenna and to decode at least one channel of video broadcast content from the unidirectional broadcast satellite signal based upon an authorization obtained over an Internet backchannel;
a wireless radio; and
signal processing circuitry configured to operate the wireless radio to:
discover an ad hoc network;
join the ad hoc network as a node; and
provide the Internet backchannel through the ad hoc network, whereby the authorization can be obtained.

105. The device of claim 104 wherein the signal processing circuitry is further configured to operate the node as one or more of a source and a destination of peer-to-peer traffic within the ad hoc network.

106. The device of claim 104 wherein the signal processing circuitry is configured to communicate over the ad hoc network to authorize the satellite receiver to decode the at least one channel of video broadcast content.

107. The device of claim 104 wherein the signal processing circuitry is further configured to deliver broadband Internet connectivity to a user from the ad hoc network.

108. The device of claim 104 wherein one or more of the satellite receiver, the wireless radio, and the signal processing circuitry are integrated into a set top box with a connector for delivering the at least one channel of video broadcast content to a television.

109-127. (canceled)
